(19) United States
(12) Patent Application Publication
(10) Pub. No.: US 2026/0010981 A1
(43) Pub. Date: Jan. 8, 2026

(54) IMAGE GENERATION APPARATUS, IMAGE GENERATION METHOD, AND STORAGE MEDIUM

(71) Applicant: CANON KABUSHIKI KAISHA, Tokyo (JP)

(72) Inventors: YOSHIHIKO IWASE, Kanagawa (JP); HIROKI UCHIDA, Tokyo (JP)

(21) Appl. No.: 19/329,352

(22) Filed: Sep. 15, 2025

Related U.S. Application Data
(63) Continuation of application No. PCT/JP2024/009262, filed on Mar. 11, 2024.

(30) Foreign Application Priority Data
Mar. 27, 2023 (JP) 2023-050409

(51) Int. Cl. G06T 5/60; G06T 7/00

(52) U.S. Cl. CPC G06T 5/60; G06T 7/0014; G06T 2207/10024; G06T 2207/10101; G06T 2207/20081; G06T 2207/20084; G06T 2207/30041

(57) ABSTRACT

An image generation apparatus includes an image acquisition unit configured to acquire an ophthalmic examination image, and an output unit configured to input the ophthalmic examination image and at least one contrast time as input data of an image generation model configured to generate a contrast-enhanced image depicting a contrast effect, and thereby provide output of at least one contrast-enhanced image output as output data of the image generation model along with the at least one contrast time.

### CROSS-REFERENCE TO RELATED APPLICATIONS

This application is a Continuation of International Patent Application No. PCT/JP2024/009262, filed Mar. 11, 2024, which claims the benefit of Japanese Patent Application No. 2023-050409, filed Mar. 27, 2023, both of which are hereby incorporated by reference herein in their entirety.

### BACKGROUND

### Field of the Technology

The present disclosure relates to an image generation apparatus and an image generation method.

### Description of the Related Art

In the medical field, to identify diseases in subjects or observe the degree of disease, contrast images may be acquired over time using contrast agents that enable imaging with emphasized visualization of blood flow and the like, and used for diagnosis. For example, contrast-enhanced examinations are performed using various imaging apparatuses, such as fluorescein angiography (FA) examination using a fundus camera, multiphase contrast-enhanced examination using an X-ray computed tomography (CT) device, and Sonazoid contrast-enhanced ultrasound examination using an ultrasound diagnostic device (echo). While contrast images acquired through contrast-enhanced examinations are often useful as diagnostic information, contrast agents may cause severe symptoms in some subjects, and examinations using radiation have adverse effects due to radiation exposure. In view of this, contrast-enhanced examinations may not be able to be performed multiple times, or may not be able to be performed even once.

In recent deep learning technology, converting images from one domain to another has also been proposed. International Publication No. WO 2019/142910 describes a technique for generating a model that, when a fundus examination image is input, outputs an image reproducing a map indicating abnormal regions. Alireza Tavakkoli, Sharif Amit Kamran, Khondker Fariha Hossain, Stewart Lee Zuckerbrod, “A novel deep learning conditional generative adversarial network for producing angiography images from retinal fundus photographs.”, Sci Rep 10, 21580 (2020), <https://doi.org/10.1038/s41598-020-78696-2> (published Dec. 9, 2020) describes a technique for generating a model that, when retinal fundus photographs taken without using a contrast agent are input, outputs images resembling FA examination images.

However, the conventional techniques have been insufficient to suitably acquire images depicting contrast effects corresponding to a specific contrast time.

### SUMMARY

The present disclosure is directed to providing a mechanism that can suitably acquire and display images depicting contrast effects corresponding to a specific contrast time.

According to an aspect of the present disclosure, an image generation apparatus includes an image acquisition unit configured to acquire an ophthalmic examination image, and an output unit configured to input the acquired ophthalmic examination image and at least one contrast time as input data of an image generation model configured to generate a contrast-enhanced image depicting a contrast effect, and thereby provide output of at least one contrast-enhanced image output as output data of the image generation model along with the at least one contrast time.

Features of the present disclosure will become apparent from the following description of embodiments with reference to the attached drawings.

### BRIEF DESCRIPTION OF THE DRAWINGS

FIG. 1 is a diagram illustrating an example of a schematic configuration of an image generation system including an image generation apparatus according to a first embodiment.

FIG. 2 is a diagram for describing the concept of an image generation model included in an output unit of the image generation apparatus according to the first embodiment.

FIG. 3 is a diagram for describing training of the image generation model included in the output unit of the image generation apparatus according to the first embodiment.

FIG. 4 is a diagram for describing calculation target regions where loss is calculated in training the image generation model included in the output unit of the image generation apparatus according to the first embodiment.

FIG. 5 is a diagram illustrating an example of a graphical user interface (GUI) screen displayed on a display of the image generation apparatus according to the first embodiment.

FIG. 6 is a flowchart illustrating an example of a processing procedure for a control method of the image generation apparatus according to the first embodiment.

FIG. 7 is a diagram illustrating a first modification of the first embodiment and intended to describe a contrast time period (contrast duration) when a fluorescein angiography (FA) examination image that is a moving image constituting teaching data used in training the image generation model is recorded.

FIG. 8 is a diagram illustrating the first modification of the first embodiment, illustrating an example of a relationship between a contrast-enhanced image that is a moving image output by the image generation model and a ground truth image (FA examination image) that is a moving image constituting the teaching data.

FIG. 9 is a diagram illustrating a second modification of the first embodiment, illustrating an example of an optical coherence tomography angiography (OCTA) image and FA examination images.

FIG. 10 is a flowchart illustrating the second modification of the first embodiment, illustrating an example of a processing procedure for alignment processing between OCTA and FA images.

FIG. 11 is a diagram illustrating an example of a schematic configuration of an image generation system including an image generation apparatus according to a second embodiment.

FIG. 12 is a diagram illustrating an example of a GUI screen displayed on a display of the image generation apparatus according to the second embodiment.

FIG. 13 is a flowchart illustrating an example of a processing procedure for a control method of the image generation apparatus according to the second embodiment.

FIG. 14 is a diagram for describing a concept of an image generation model included in an output unit of an image generation apparatus according to a third embodiment.

FIG. 15 is a diagram for describing another concept of the image generation model included in the output unit of the image generation apparatus according to the third embodiment.

FIG. 16 is a diagram illustrating the third embodiment, illustrating an example of periods with and without left-and right-eye FA examination images constituting teaching data used in training the image generation model.

FIG. 17 is a diagram for describing training of the image generation model included in the output unit of the image generation apparatus according to the third embodiment.

FIG. 18 is a flowchart illustrating an example of a processing procedure for a control method of the image generation apparatus according to a first modification of the third embodiment.

FIG. 19 is a flowchart illustrating a third modification of the third embodiment, illustrating an example of a processing procedure for interpolated image generation processing.

FIG. 20 is a diagram illustrating the third modification of the third embodiment, illustrating an example of periods with and without FA examination images constituting the teaching data used in training the image generation model.

FIG. 21 is a diagram illustrating the third modification of the third embodiment and intended to describe an effective pixel region common to the immediately preceding FA examination image and immediately following FA examination image illustrated in FIG. 20.

FIG. 22 is a diagram illustrating the third modification of the third embodiment, illustrating an example of periods with and without FA examination images constituting the teaching data used in training the image generation model.

FIG. 23 is a diagram illustrating the third modification of the third embodiment and intended to describe an effective pixel region in a case where the immediately following FA examination image illustrated in FIG. 22 is the first FA examination image captured in the FA examination.

FIG. 24 is a diagram for describing a concept of an image generation model included in an output unit of an image generation apparatus according to a fourth embodiment.

FIG. 25 is a chart illustrating the fourth embodiment and intended to describe the presence or absence of FA examination images constituting teaching data used in training the image generation model.

FIG. 26 is a diagram for describing training of the image generation model included in the output unit of the image generation apparatus according to the fourth embodiment.

FIG. 27 is a diagram for describing the training of the image generation model included in the output unit of the image generation apparatus according to the fourth embodiment.

FIG. 28 is a diagram illustrating an example of a GUI screen displayed on a display of the image generation apparatus according to the fourth embodiment.

FIG. 29 is a flowchart illustrating an example of a processing procedure for a control method of the image generation apparatus according to the fourth embodiment.

FIG. 30 is a diagram for describing a concept of an image generation model included in an output unit of an image generation apparatus according to a fifth embodiment.

FIG. 31 is a diagram for describing training of the image generation model included in the output unit of the image generation apparatus according to the fifth embodiment.

FIG. 32 is a flowchart illustrating an example of a processing procedure for a control method of an image generation apparatus according to a sixth embodiment.

FIG. 33 is a diagram illustrating an example of a GUI screen displayed on a display of an image generation apparatus according to a seventh embodiment.

FIG. 34 is a diagram illustrating an example of a schematic configuration of an image generation system including an image generation apparatus according to an eighth embodiment.

FIG. 35A is a diagram illustrating an example of a GUI screen for setting generation times of a moving image to be output by an image generation model of the image generation apparatus according to the eighth embodiment.

FIG. 35B is a diagram illustrating another example of the GUI screen for setting the generation times of the moving image to be output by the image generation model of the image generation apparatus according to the eighth embodiment.

FIG. 36 is a diagram illustrating an example of a GUI screen displayed on a display of the image generation apparatus according to the eighth embodiment.

FIG. 37A is a diagram illustrating an example of an image and an imaging time stored in a storage unit of the image generation apparatus according to the eighth embodiment.

FIG. 37B is a diagram illustrating an example of an image and an imaging time stored in the storage unit of the image generation apparatus according to the eighth embodiment.

FIG. 37C is a diagram illustrating an example of images and an imaging time stored in the storage unit of the image generation apparatus according to the eighth embodiment.

FIG. 38 is a diagram illustrating an example of a GUI screen displayed on a display of an image generation apparatus according to a ninth embodiment.

FIG. 39 is a diagram illustrating an example of a GUI screen displayed on the display of the image generation apparatus according to the ninth embodiment.

FIG. 40 is a diagram illustrating an example of a GUI screen displayed on a display of an image generation apparatus according to a tenth embodiment.

FIG. 41 is a diagram for describing the concept of an image generation model and an image determination model included in an output unit of an image generation apparatus according to an eleventh embodiment.

FIG. 42 is a diagram for describing the concept of the image generation model and the image determination model included in the output unit of the image generation apparatus according to the eleventh embodiment.

FIG. 43 is a diagram illustrating an example of a GUI screen displayed on a display of an image generation apparatus according to a twelfth embodiment.

FIG. 44 is a diagram illustrating an example of a schematic configuration of an image generation model generation apparatus according to a thirteenth embodiment.

### DESCRIPTION OF THE EMBODIMENTS

Modes (embodiments) for carrying out the present disclosure will be described below with reference to the drawings. While the following embodiments of the present disclosure deal with examples assuming two-dimensional or three-dimensional still or moving images, the drawings include illustrations using two-dimensional still images for clarity of description. In other words, the images handled in the following embodiments of the present disclosure are not limited to two-dimensional still images.

### First Embodiment

A first embodiment will initially be described.

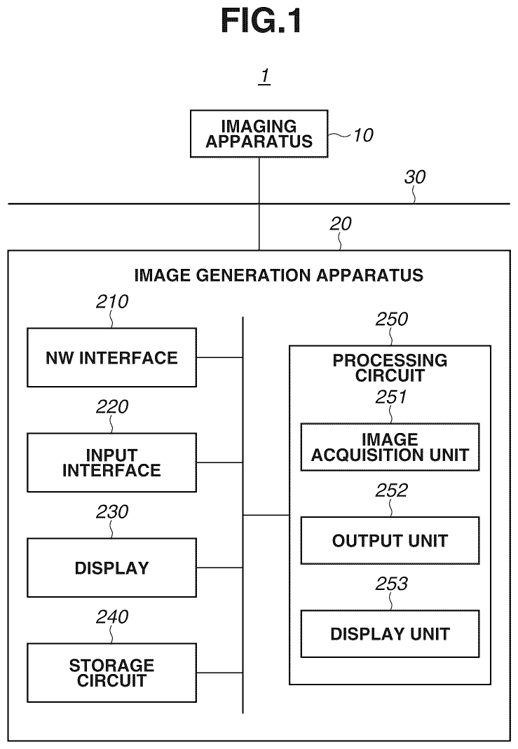

FIG. 1 is a diagram illustrating an example of a schematic configuration of an image generation system 1 including an image generation apparatus 20 according to the first embodiment. As illustrated in FIG. 1, the image generation system 1 includes an imaging apparatus 10, the image generation apparatus 20, and a network 30. The imaging apparatus 10 and the image generation apparatus 20 are communicably connected via the network 30. The schematic configuration of the image generation system 1 illustrated in FIG. 1 is merely an example, and the numbers of respective apparatuses may be freely changed. In the image generation system 1, apparatuses not illustrated in FIG. 1 may also be connected to the network 30.

In the first embodiment, the imaging apparatus 10 is an optical coherence tomography (OCT) apparatus capable of imaging the fundus of an eye to be examined, for example. In the first embodiment, the imaging apparatus 10 need only be capable of acquiring optical coherence tomography angiography (OCTA) images that are medical images derived from imaging by an OCT device. The imaging apparatus 10 can thus be replaced with an image management system that stores and manages OCTA images, for example.

As illustrated in FIG. 1, the image generation apparatus 20 includes a network (NW) interface 210, an input interface 220, a display 230 that is a display device, a storage circuit 240, and a processing circuit 250. The storage circuit 240 is an example of a storage unit according to the present disclosure. The processing circuit 250 is an example of a processing unit according to the present disclosure.

The NW interface 210 is communicably connected to the input interface 220, the display 230, the storage circuit 240, and the processing circuit 250. The NW interface 210 controls transmission and communication of various types of information and various types of data (including image data) with apparatuses connected via the NW 30. For example, the NW interface 210 is implemented by a NW card, a NW adaptor, a network interface controller (NIC), or the like.

The input interface 220 is communicably connected to the NW interface 210, the display 230, the storage circuit 240, and the processing circuit 250. The input interface 220 converts input operations accepted from the operator into input signals that are electrical signals, and inputs the input signals to the processing circuit 250 and the like. For example, the input interface 220 can be implemented by a trackball, switch buttons, a mouse, a keyboard, and the like. As another example, the input interface 220 can be implemented by a touchpad where input operations are made by touching the operation surface, a touchscreen where a display screen and a touchpad are integrated, a non-contact input circuit using optical sensors, a voice input circuit, and the like. Note that the input interface 220 is not limited to ones equipped with physical operation parts, such as a mouse and a keyboard. Examples of the input interface 220 also include a component unit that receives electrical signals corresponding to input operations from an external input device disposed separate from the image generation apparatus 20 and inputs the electrical signals to the processing circuit 250 and the like as input signals.

The display 230 is communicably connected to the NW interface 210, the input interface 220, the storage circuit 240, and the processing circuit 250. The display 230 displays various types of information and various types of data (including image data) output from the processing circuit 250. For example, the display 230 is implemented by a liquid crystal display, a cathode ray tube (CRT) display, an organic electroluminescence (EL) display, a plasma display, a touchscreen, or the like.

The storage circuit 240 is communicably connected to the NW interface 210, the input interface 220, the display 230, and the processing circuit 250. The storage circuit 240 stores various types of information and various types of data (including image data). The storage circuit 240 further stores programs for the processing circuit 250 to read and execute to implement various functions, for example. The storage circuit 240 can be implemented by semiconductor memory devices such as a random access memory (RAM) and a flash memory, a hard disk, an optical disc, and the like, for example.

The processing circuit 250 comprehensively controls operation of the image generation apparatus 20 and performs various types of processing. As illustrated in FIG. 1, the processing circuit 250 includes an image acquisition unit 251, an output unit 252, and a display unit 253. In the present embodiment, programs for implementing the functions of the component units (251 to 253) of the processing circuit 250 are stored in the storage circuit 240 in the form of computer-executable programs. For example, the processing circuit 250 is a processor that implements the functions of the component units (251 to 253) by reading the programs from the storage circuit 240 and executing the programs. In FIG. 1, the processing circuit 250 is illustrated as a single processor that implements the image acquisition unit 251, the output unit 252, and the display unit 253. However, the processing circuit 250 may be constituted by a combination of a plurality of independent processors. In such a case, the plurality of independent processors constituting the processing circuit 250 may be configured to implement the functions of the respective component units (251 to 253) by executing the programs.

While FIG. 1 illustrates a case where the storage circuit 240 is assumed to be a single storage circuit, the storage circuit 240 may be constituted by a plurality of storage circuits in a distributed manner. In such a case, the processing circuit 250 may be configured to read the programs from the respective corresponding storage circuits and execute the programs.

The foregoing term “processor” can refer to a central processing unit (CPU) or a graphical processing unit (GPU), for example. The foregoing term “processor” can also refer to an application-specific integrated circuit (ASIC), for example. The foregoing term “processor” can also refer to a programmable logic device (such as a simple programmable logic device [SPLD]), for example. The foregoing term “processor” can also refer to a complex programmable logic device (CPLD), for example. The foregoing term “processor” can also refer to a field-programmable gate array (FPGA), for example. In the present embodiment, the processor implements the functions of the component units by reading the programs stored in the storage circuit 240 and executing the programs. Instead of storing the programs in the storage circuit 240, the programs may be directly built in the processor circuitry. In such a case, the processor implements the functions of the component units by reading the programs built in its circuitry and executing the programs.

The image acquisition unit 251 has a function of acquiring medical images that are still images of an object, or examination target (in the present embodiment, eye to be examined), captured by the imaging apparatus 10. Specifically, for example, the medical images of the present embodiment are OCTA images that are fundus examination images of the fundus of the eye to be examined. OCTA images will now be described. An OCTA image is an image that is generated as a blood vessel image of the fundus of an eye to be examined by projecting three-dimensional motion contrast data of the fundus of the eye to be examined, acquired by an OCT device applied as the imaging apparatus 10, upon a two-dimensional plane. As employed herein, motion contrast data refers to data obtained by repeatedly imaging the same cross section of a measurement target (in the present embodiment, the fundus of the eye to be examined) with an OCT device and detecting temporal changes in the measurement target between the imaging sessions. This motion contrast data is obtained, for example, by calculating temporal changes in the phase, vector, or intensity of complex OCT signals from differences, ratios, correlations, or the like. A two-dimensional frontal image of the fundus of the eye to be examined is generated as an OCTA image by specifying a range in the depth direction, such as layers in the fundus of the eye to be examined, from this motion contrast data. In other words, by specifying different depth ranges in the fundus of the eye to be examined, OCTA images of given ranges such as the superficial layer, deep layer, outer layer, and choroidal vascular NW can be generated. The types of OCTA images are not limited thereto. OCTA images with different depth range settings may be generated by changing the reference layer and the offset value. The present embodiment will be described by using superficial layer OCTA images and fluorescein angiography (FA) examination images of the fundus of the eye to be examined as an example.

The output unit 252 has a function of outputting a contrast-enhanced image where contrast effects corresponding to a contrast duration including at least one contrast time are depicted, based on an OCTA image that is a medical image acquired by the image acquisition unit 251. In particular, if the contrast duration includes only one contrast time, the output unit 252 outputs a contrast-enhanced image equivalent to a still image. If the contrast duration includes a plurality of contrast times, the output unit 252 outputs a contrast-enhanced image equivalent to a moving image including a plurality of still images. In the present embodiment, the output unit 252 outputs a moving image as a contrast-enhanced image corresponding to a contrast duration including a plurality of contrast times. Specifically, the contrast-enhanced image according to the present embodiment is an FA examination image-like pseudo contrast image of moving image format where temporal changes in contrast effects are depicted, as would be acquired in FA examination. The output unit 252 according to the present embodiment sets a predetermined frames per second (FPS) at which changes in contrast effects are easily observable, like 10 FPS, as the playback speed of the contrast-enhanced image that is a moving image. Moreover, the output unit 252 may output the contrast-enhanced image to the storage circuit 240, for example. The output unit 252 may be configured to output the contrast-enhanced image to not-illustrated other devices via the NW interface 210 and the NW 30, and simultaneously output the contrast-enhanced image to the display 230 as well.

The display unit 253 has a function of displaying the contrast-enhanced image output from the output unit 252 on the display 230 in a manner easily observable by the operator. Here, the output unit 252 may function as an example of a display control unit according to the present disclosure by outputting the contrast-enhanced image to the display 230 that is a display device. In other words, the output unit 252 may include the display control unit according to the present disclosure. Alternatively, the output unit 252 may include the function of the display unit 253, in which case the display unit 253 is not an essential component. The output unit 252 may function as an example of a storage control unit according to the present disclosure by outputting the contrast-enhanced image to the storage circuit 240. In other words, the output unit 252 may include the storage control unit according to the present disclosure.

In the present embodiment, the output unit 252 includes an image generation model that inputs a medical image that is a still image and outputs a contrast-enhanced image that is a moving image depicting contrast effects corresponding to a contrast duration including a plurality of contrast times, based on the medical image.

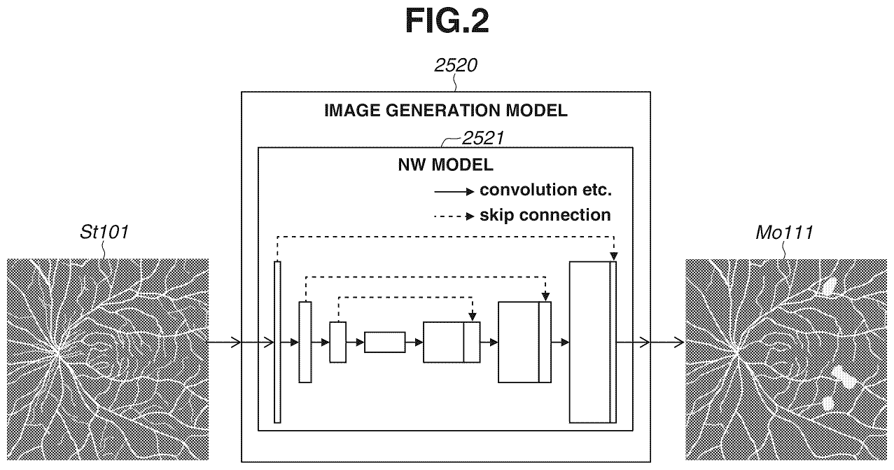

FIG. 2 is a diagram for describing the concept of an image generation model 2520 included in the output unit 252 of the image generation apparatus 20 according to the first embodiment.

The image generation model 2520 illustrated in FIG. 2 is a model including an image processing system that outputs a contrast-enhanced image using rule-based approaches or machine learning (in particular, deep learning techniques), for example. In the present embodiment, the image generation model 2520 is a model trained using training data including a medical image group related to medical images, a contrast image group related to the medical image group, and an imaging condition group related to the contrast image group, for example. Hereinafter, the image generation model 2520 including an image processing system using deep learning techniques will be described.

The image generation model 2520 illustrated in FIG. 2 includes a NW model 2521 based on U-Net as the image processing system using deep learning techniques. U-Net refers to a conventional NW model using deep learning techniques. Specifically, U-Net is trained using a dataset including paired image groups of input images and corresponding output images. When an image is input to the image generation model 2520 including well-trained U-Net, a plausible image corresponding to the input image can be output based on the tendencies of the dataset used for the training. It has been known that U-Net can be applied to image segmentation processing, image quality enhancement, image domain conversion, and the like depending on the dataset.

As illustrated in FIG. 2, the image generation model 2520 tensorizes an input image St101 that is a still image, inputs the resulting tensor to the NW model 2521, converts the tensor output by the NW model 2521 into a moving image, and outputs the moving image as an output image Mo111. If U-Net is employed as the NW model 2521, the U-Net needs to be modified. In the description of the present embodiment, a tensor refers to a format where image pixel values and the like are expressed as a multidimensional array, and serves as the data input/output format of the NW model 2521. Images and tensors are mutually convertible.

A specific example will now be described. Suppose that the total number of moving image frames of the output image Mo111 that is the moving image to be output is N, and the input image St101 that is a still image is tensorized into a shape of “Cᵢₙ×Hᵢₙ×Wᵢₙ”. Here, “Cᵢₙ” represents the number of channels, “Hᵢₙ” the height of the input tensor, and “Wᵢₙ” the width of the input tensor. In particular, if “Cᵢₙ” is 1, the spatial axis for the number of channels can be ignored. The NW model 2521, a modified U-Net, increases the elements constituting the input tensor, performs shape transformation before the final layer, and outputs a tensor in the shape of “N×Cₒᵤₜ×Hₒᵤₜ×Wₒᵤₜ”. Here, “Hₒᵤₜ” represents the height of the output tensor, and “Wₒᵤₜ” the width of the output sensor. The tensor output from the NW model 2521 is divided into N tensors in the shape of “Cₒᵤₜ×Hₒᵤₜ×Wₒᵤₜ”, and the divided tensors are converted into respective moving image frames. The converted moving image frames are connected and output from the image generation model 2520 as the output image Mo111 that is a single moving image. The tensor shapes are not limited to those described in the present embodiment, and other shapes that can achieve a similar purpose may be used. While U-Net is described in the present embodiment, other NW models that can achieve a similar purpose may be employed. The present embodiment deals with two-dimensional images. In other embodiments where three-dimensional images are handled, such handling can be accommodated by adding a depth space to the tensor shapes described here.

The dataset for training the image generation model 2520 including the U-Net-based NW model 2521 will now be described. The dataset is configured as a teaching data group acquired from a plurality of examination targets, with an OCTA image that is a still image and an FA examination image that is a moving image for a predetermined contrast time period (contrast duration), which are captured from the same examination target (i.e., eye to be examined), as a single set (pair) of teaching data. A contrast time refers to a time indicating the elapsed time from a reference point in time (reference time) such as when the contrast agent is injected into the subject, when the first image is captured, and when the contrast effect on the organ is first observed in the acquired image. A predetermined contrast time period (contrast duration) refers to a period defined as, for example, contrast times of 0 sec to 60 sec. If the FA examination image is a 1-FPS moving image, there are 61 moving image frames corresponding to 61 contrast times during the period at intervals of 1 sec. Some or all of the moving image frames constituting the FA examination image that is a moving image may be complemented with FA examination images that are still images.

FA examination images that are moving images for a predetermined contrast time period (contrast duration) might not be constituted by the same number of moving image frames depending on factors such as the type and settings of the imaging apparatus 10. The moving image frames are therefore sampled so that the numbers of moving image frames constituting the FA examination images that are the moving images constituting the teaching data are the same in all the sets (pairs) of teaching data. The FA examination images that are the moving images constituting the final dataset are thus constructed with a fixed number of moving image frames by performing the foregoing sampling or other processing as needed. Here, the number of moving image frames coincides with the number of moving image frames of the contrast-enhanced image that is the moving image for the image generation model 2520 to output.

Depending on the configuration of the NW model 2521, aligning the input images and ground truth images in the teaching data may provide better results. Specifically, for the U-Net-based NW model 2521, OCTA images as the input images and moving image frame groups constituting FA examination images as the ground truth images in the teaching data acquired by capturing the same examination targets can be aligned with each other in advance. For example, if this alignment is anatomically performed in advance through manual image processing, image registration processing, or the like, the depiction of contrast effects in contrast-enhanced images output by the image generation model 2520 more closely resembles actual FA examination images. Since OCTA images and FA examination images are acquired by different types of imaging devices, the manner of depiction differs significantly, and anatomical alignment may be difficult depending on conditions such as contrast times. In such a case, first, take at least one set that is relatively easy to align anatomically among the sets (pairs) of OCTA images and moving image frames constituting FA examination images. Transform the moving image frame for alignment by referring to the anatomical position of the OCTA image. Then, transform the rest of the moving image frames by referring to the anatomical position of the transformed moving image frame. This enables more favorable anatomical alignment even in situations where the OCTA images and the FA examination images are difficult to align anatomically. As a result, the manner of depiction of contrast effects in contrast-enhanced images output from the image generation model 2520 more closely resembles actual FA examination images.

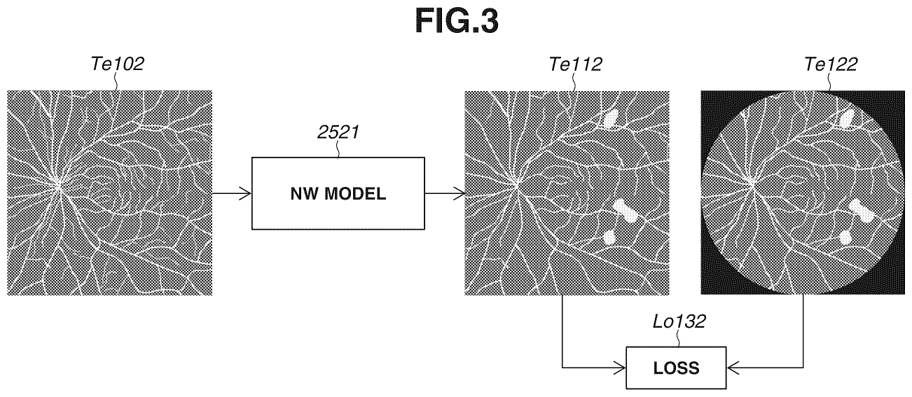

FIG. 3 is a diagram for describing the training of the image generation model 2520 included in the output unit 252 of the image generation apparatus 20 according to the first embodiment. In FIG. 3, components similar to those illustrated in FIG. 2 are denoted by the same reference numerals. A detailed description thereof will be omitted. The training of the image generation model 2520 using a set of teaching data, i.e., processing for updating parameters constituting the NW model 2521 included in the image generation model 2520 will now be described with reference to FIG. 3.

In FIG. 3, an input tensor Te102 obtained by tensorizing an OCTA image constituting the teaching data is initially input to the NW model 2521. The NW model 2521 outputs an output tensor Te112 corresponding to a contrast-enhanced image that is a moving image. The image generation model 2520 then calculates a loss Lo132, which is the error between a ground truth tensor Te122 obtained by tensorizing an FA examination image that is the moving image constituting the same teaching data and the output sensor Te112. Finally, the image generation model 2520 updates the parameters constituting the NW model 2521 so that the loss Lo132 decreases. This series of update processes is repeated using the teaching data group assigned for training in the dataset, until the NW model 2521 is sufficiently trained. While a single round of update processing is described to use a set of teaching data for the sake of description, multiple teaching data groups may be used in a single round of update processing for purposes such as reducing the training time and stabilizing the training process. If accuracy evaluation or the like using teaching data for validation is performed during the training process and the image generation model 2520 is found to be sufficiently trained, the image generation accuracy may be determined to be sufficiently high and the training process may be stopped (early stopping).

The accuracy evaluation and error (loss) calculation between the FA examination images (or tensors thereof) in the teaching data assigned for training or validation and the contrast-enhanced images (or tensors thereof) output from the image generation model 2520 can be performed using calculation methods based on the following techniques. Specifically, methods for quantifying errors and degrees of similarity using techniques such as the mean squared error (MSE) and the structural similarity (SSIM) can be employed. To perform the accuracy evaluation and error (loss) calculation for moving images, the calculation methods based on techniques such as the MSE and SSIM can be used in a form either specific to moving images or still images. Examples of the form specific to moving images include performing calculations on the multidimensional arrays “width >height × time” of the moving images. Examples of the form specific to still images include performing calculations on the multidimensional arrays “width×height” of the moving image frames constituting the moving images and averaging the results.

To perform the accuracy evaluation and error (loss) calculation during the training of the image generation model 2520, the calculation targets may be selected by taking into consideration semantic regions that are regions within the images included in the training data and that can be segmented based on the manner of depiction in the images or information associated with the images. Specifically, examples of semantic regions include masked regions and non-masked regions depicted within the images included in the training data, regions where patient information and imaging information (such as date and time and an imaging protocol name) are printed, and regions related to organ sites and conditions (such as normal tissue, abnormal tissue, bleeding, inflammation, white spots, and treatment scars). Examples of semantic regions also include bright regions or dark regions within the images included in the training data, high-or low-image-quality regions, and regions where image processing such as alignment is successful or failed. Semantic regions are thus regions within the images included in the training data that can be segmented based on the manner of depiction in the images or information associated with the images. For example, fundus photographs and FA examination images acquired by fundus cameras include masked regions (such as regions filled in black) in the peripheral portions of the images depending on the imaging angle of view. Since the masked regions are where organs do not appear (that do not affect diagnosis), the performance and characteristics of the image generation model 2520 may be adjusted during the training of the image generation model 2520 by targeting only non-masked regions that affect diagnosis for the accuracy evaluation and error (loss) calculation.

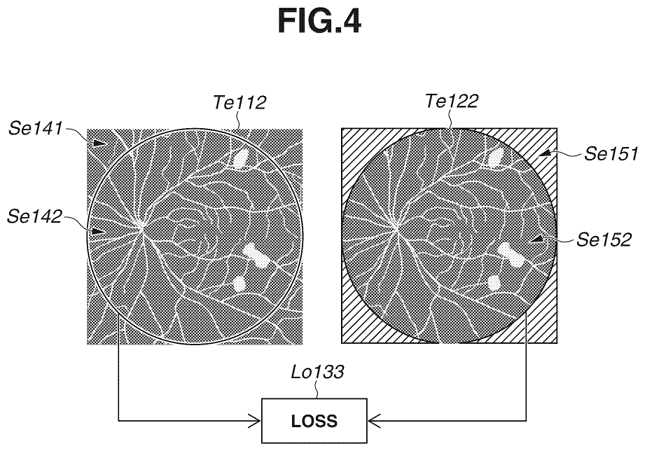

FIG. 4 is a diagram for describing calculation target regions where loss is calculated in training the image generation model 2520 included in the output unit 252 of the image generation apparatus 20 according to the first embodiment. In FIG. 4, components similar to those illustrated in FIG. 3 are denoted by the same reference numerals. A detailed description thereof will be omitted.

For example, as illustrated in FIG. 4, an FA examination image may include a masked region Se151, in which case the masked region Se151 can be excluded from the accuracy evaluation and error (loss) calculation. If the accuracy evaluation and error (loss) calculation between a plurality of images with semantic regions taken into consideration use the MSE or other calculation methods that account for differences between pixels at the corresponding coordinates across the images, care is to be taken to make sure that the pixel regions targeted for the calculation in the plurality of images are common. A specific description will be given with reference to FIG. 4. In calculating a loss Lo133, a non-masked region Se152 in the ground truth tensor Te122 of the FA examination image and a region Se142 corresponding to the non-masked region Se152 in terms of coordinates are assumed as the calculation target regions.

If the images targeted for the accuracy evaluation and error (loss) calculation are moving images, the positions and types of semantic regions may vary from one frame to another among the moving image frames constituting the moving images. For such a reason, the accuracy evaluation and error (loss) calculation techniques and the calculation target regions may be changed from one moving image frame to another accordingly. In particular, if only the non-masked region Se152 is subjected to the calculation of the loss Lo132 for updating the parameters constituting the NW model 2521, the contrast-enhanced image output from the image generation model 2520 lacks the depiction of features corresponding to the masked region Se151. In other words, since contrast effects are also depicted in the region Se141, the resulting contrast-enhanced image ends up providing observable contrast effects over the entire depiction area of the OCTA image input to the image generation model 2520. Alternatively, the features corresponding to the masked region Se151 may be depicted without taking account of semantic regions, so that an image more closely resembling actual contrast images is presented to the operator for reduced sense of unnaturalness. Note that conventional rule-based or machine learning-based image processing can be used to extract semantic regions to be targeted for the accuracy evaluation and error (loss) calculation. Since the non-masked region in the FA examination image is a fixed region determined by the imaging apparatus 10, the non-masked region may be mechanically extracted and subjected to the accuracy evaluation and error (loss) calculation.

Up to this point, a method for training the image generation model 2520 by updating (optimizing) the parameters constituting the NW model 2521 based on the error between the ground truth tensor Te122 and the output tensor Te112 output from the NW model 2521 has been described. However, the present embodiment is not limited to this method. The parameters constituting the NW model 2521 may be updated by applying generative adversarial network (GAN)-related techniques with image inputs, such as Conditional GAN which is a conventional deep learning technique. For example, the parameters constituting the NW model 2521, which corresponds to a generator NW in Conditional GAN, may be updated while making the following determination on the contrast-enhanced image generated by the NW model 2521. Specifically, the parameters constituting the NW model 2521 may be updated while determining whether the contrast-enhanced image appears to be genuine (FA examination image) or fake (FA examination image-like image) using a discriminator NW.

The image generation model 2520 trained by the foregoing processing, when an OCTA image is input, can output a contrast-enhanced image that is a moving image where a plausible contrast image is depicted based on the teaching data group assigned for training in the dataset. In other words, the image generation model 2520 can output an FA examination image-like pseudo contrast image (contrast-enhanced image) of moving image format depicting temporal changes in contrast effects, as would be acquired in FA examination.

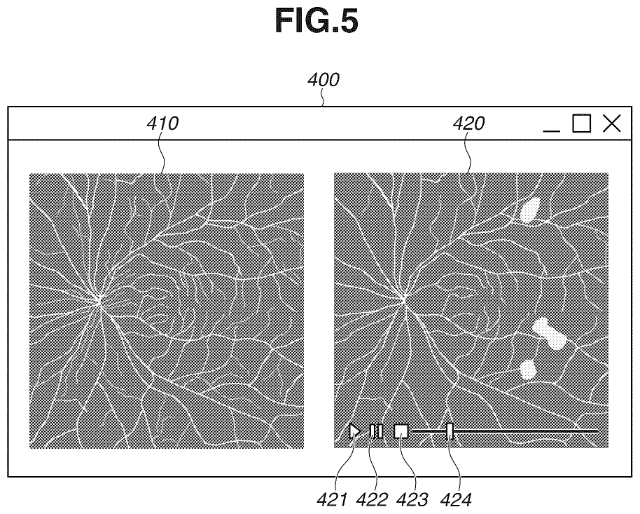

FIG. 5 is a diagram illustrating an example of a graphical user interface (GUI) screen 400 displayed on the display 230 of the image generation apparatus 20 according to the first embodiment.

The display unit 253 performs processing for displaying the GUI screen 400 such as illustrated in FIG. 5 on the display 230. Specifically, the display unit 253 performs processing for displaying the medical image acquired by the image acquisition unit 251 (in the present embodiment, OCTA image) in an image display area 410 of the GUI screen 400 illustrated in FIG. 5. The display unit 253 also performs processing for displaying the contrast-enhanced image output from the output unit 252 in an image display area 420 of the GUI screen 400 illustrated in FIG. 5. More specifically, in the present embodiment, the display unit 253 performs processing for displaying a contrast-enhanced image that is a moving image in the image display area 420. This enables the operator to observe the contrast-enhanced image by visually observing the image display area 420 of the GUI screen 400. The image display area 420 of the GUI screen 400 also includes operation tools that enable the operator to operate the moving image that is the contrast-enhanced image. The image display area 420 includes, as the operation tools, a playback button 421 for starting playback of the moving image, a pause button 422 for pausing the playback of the moving image, a stop button 423 for stopping the playback of the moving image, and a seek bar 424 for changing the playback position of the moving image. The moving image that is the contrast-enhanced image displayed in the image display area 420 may automatically start playing, or may be paused at a playback position corresponding to a contrast time useful for diagnosis. The GUI screen 400 illustrated in FIG. 5 displays the OCTA image that is the medical image acquired by the image acquisition unit 251 in the image display area 410 for improved diagnostic efficiency during observation by comparison with the contrast-enhanced image displayed in the image display area 420.

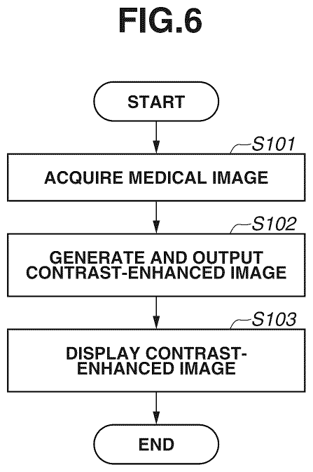

FIG. 6 is a flowchart illustrating an example of a processing procedure for a control method of the image generation apparatus 20 according to the first embodiment.

When the processing of the flowchart illustrated in FIG. 6 is started, in step S101, the image acquisition unit 251 initially acquires an OCTA image that is a medical image from the imaging apparatus 10, for example.

In step S102, the output unit 252 generates a contrast-enhanced image depicting contrast effects corresponding to a contrast duration including a plurality of contrast times based on the OCTA image acquired in step S101, and outputs the contrast-enhanced image. Specifically, in the present embodiment, the output unit 252 outputs a contrast-enhanced image that is an FA examination image-like pseudo contrast image of moving image format depicting temporal changes in contrast effects corresponding to the contrast duration.

In step S103, the display unit 253 displays the OCTA image acquired in step S101 in the image display area 410 of the GUI screen 400 illustrated in FIG. 5, and displays the contrast-enhanced image that is the moving image output in step S102 in the image display area 420.

Once the processing of step S103 ends, the processing of the flowchart illustrated in FIG. 6 ends.

As described above, in the image generation apparatus 20 according to the first embodiment, the image acquisition unit 251 acquires an OCTA image that is a medical image from the imaging apparatus 10, for example. The output unit 252 then outputs a contrast-enhanced image depicting contrast effects corresponding to a contrast duration including a plurality of contrast times (contrast-enhanced image of moving image format depicting the contrast effects) based on the OCTA image acquired by the image acquisition unit 251. Since the contrast duration includes a plurality of contrast times over time, a contrast-enhanced image of moving image format depicting temporal changes in contrast effects is output, for example.

With such a configuration, an image depicting contrast effects corresponding to the contrast duration including a plurality of contrast times can be suitably acquired. As a result, an FA examination image-like image depicting contrast effects corresponding to the contrast duration including contrast times when the operator wants to conduct observation can be suitably acquired, and the operator's diagnostic decision-making can be assisted.

### First Modification of First Embodiment

Next, a first modification of the foregoing first embodiment will be described as a modification of the first embodiment.

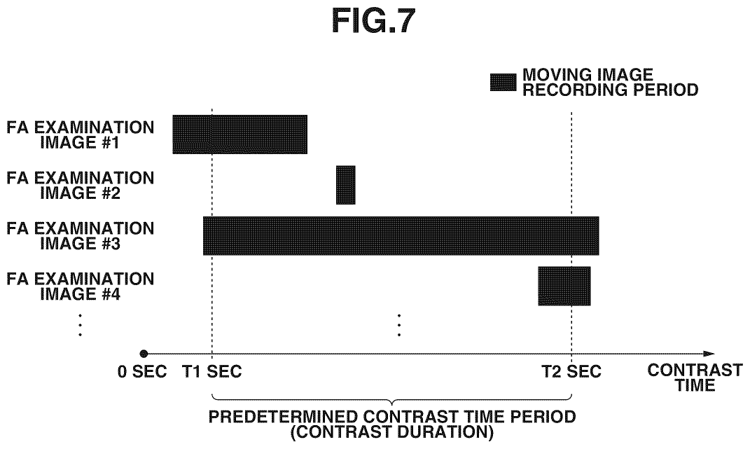

FIG. 7 is a diagram illustrating the first modification of the first embodiment and intended to describe a contrast time period (contrast duration) when FA examination images that are moving images constituting the teaching data used in training the image generation model 2520 are recorded.

As illustrated in FIG. 7, FA examination images that are moving images constituting the teaching data used in training the image generation model 2520 may include ones that last for part of a predetermined contrast time period (contrast duration) from time T1 sec to time T2 sec. The predetermined contrast time period (contrast duration) can be covered by integrating the recording periods of all the FA examination images. Moreover, if a contrast time period (contrast duration) when observation is clinically desired or a contrast time period (contrast duration) when the operator particularly wants to conduct observation can be identified, it is suitable to preferentially include FA examination images covering that contrast time period (contrast duration) in the teaching data group. In other words, it is suitable for the FA examination image group (contrast-enhanced image group) included in the training data to include more FA examination images captured during the contrast duration including the contrast times when the operator wants to conduct observation than FA examination images captured during contrast durations including other contrast times. This is effective because the image generation accuracy of the image generation model 2520 (the plausibility of depiction of the contrast-enhanced image) for the contrast time period (contrast duration) improves. In such a case, only the contrast times corresponding to the playback positions of the existing moving image frames are subjected to accuracy evaluation and error (loss) calculation.

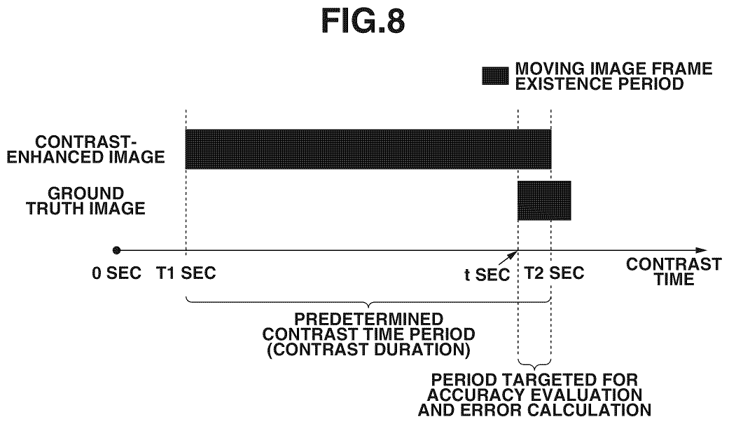

FIG. 8 is a diagram illustrating the first modification of the first embodiment, illustrating an example of a relationship between a contrast-enhanced image that is a moving image output by the image generation model 2520 and a ground truth image (FA examination image) that is a moving image constituting the teaching data.

For example, to evaluate accuracy or calculate error (loss) between the contrast-enhanced image and the ground truth image (FA examination image) illustrated in FIG. 8, the contrast time period (contrast duration) of the moving image frames included in the ground truth image, or contrast times of t sec to T2 sec, is subjected to the evaluation or calculation.

The first modification of the first embodiment also accommodates cases where FA examination images that are moving images constituting the teaching data are not recorded to cover a predetermined contrast time period (contrast duration). Even in such cases, according to the first modification of the first embodiment, an FA examination image-like pseudo image (contrast-enhanced image) of moving image format depicting temporary changes in contrast effects can be suitably acquired based on an OCTA image. An FA examination image-like image depicting contrast effects corresponding to a contrast duration including contrast times when the operator wants to conduct observation can thus be suitably acquired, and the operator's diagnostic decision-making can be assisted.

### Second Modification of First Embodiment

Next, a second modification of the foregoing first embodiment will be described as a modification of the first embodiment.

In the foregoing first embodiment, the teaching data group used in training the image generation model 2520 may include FA examination images of different imaging range sizes (i.e., different angles of view). If the imaging ranges of OCTA images and FA examination images differ greatly in size, anatomical alignment can be difficult. If the imaging ranges of OCTA images and FA examination images are substantially the same, for example, anatomical alignment tends to succeed easily since common sites and blood vessels of the examination targets (in the embodiment, eyes to be examined) are depicted.

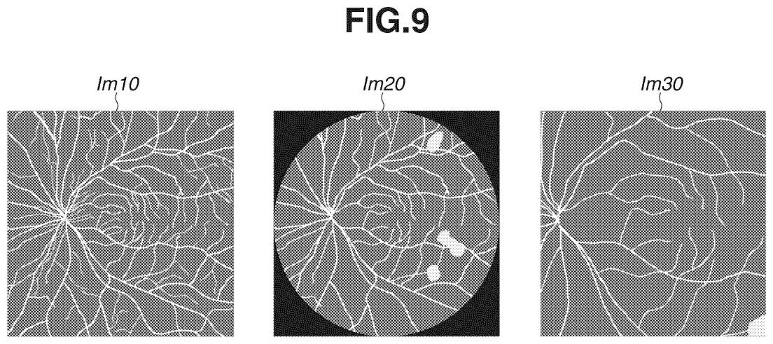

FIG. 9 is a diagram illustrating the second modification of the first embodiment, illustrating an example of an OCTA image and FA examination images. FIG. 9 illustrates a wide-area OTCA image Im10 capturing a wide area, a wide-area FA examination image Im20 capturing a wide area, and a narrow-area FA examination image Im30 capturing a narrow area. The wide-area OCTA image Im10 and the narrow-area FA examination image Im30 illustrated in FIG. 9 can be difficult to anatomically align, since the depicted sites and blood vessels differ greatly in appearance, not to mention the imaging devices being different. In such a case, the wide-area FA examination image Im20 obtained by capturing the wider area of the same examination target can be used to improve the result of the anatomical alignment.

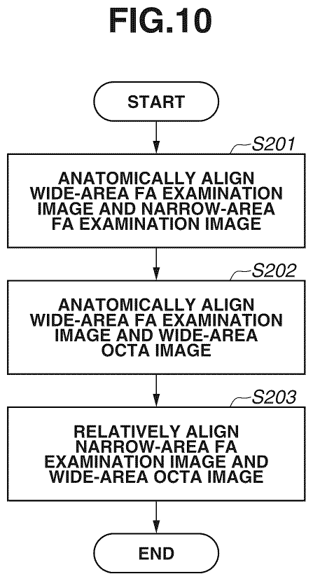

FIG. 10 is a flowchart illustrating the second modification of the first embodiment, illustrating an example of a processing procedure for alignment processing between an OCTA image and an FA examination image.

When the flowchart illustrated in FIG. 10 is started, in step S201, the image generation model 2520 initially anatomically aligns the wide-area FA examination image Im20 and the narrow-area FA examination image Im30 illustrated in FIG. 9. Since both the images are acquired from the same imaging apparatus 10, the images can be anatomically aligned.

In step S202, the image generation model 2520 anatomically aligns the wide-area FA examination image Im20 and the wide-area OCTA image Im10. Since the two images are acquired by capturing a wide area, the images can be anatomically aligned.

In step S203, the image generation model 2520 relatively aligns the wide-area OCTA image Im10 and the narrow-area FA examination image Im30. Specifically, the image generation model 2520 performs the alignment in step S203 by combining transformation information from the anatomical alignment in step S201 with transformation information from the anatomical alignment in step S202.

According to the second modification of the first embodiment, an OCTA image and an FA examination image with imaging ranges of greatly different sizes can be anatomically aligned more successfully. As a result, the contrast effects in the contrast-enhanced image output from the image generation model 2520 can be depicted more closely to actual FA examination images. In other words, an FA examination image-like pseudo image (contrast-enhanced image) of moving image format depicting temporal changes in contrast effects can be suitably acquired based on the OCTA image. An FA examination image-like pseudo image depicting contrast effects corresponding to a contrast duration including contrast times when the operator wants to conduct observation can thus be suitably acquired, and the operator's diagnostic decision-making can be assisted.

### Third Modification of First Embodiment

Next, a third modification of the foregoing first embodiment will be described as a modification of the first embodiment.

The OCTA images (medical images) constituting the dataset for training the image generation model 2520 according to the foregoing first embodiment may be replaced with other types of images where the state of the fundus of the eye to be examined is recorded.

Examples of the other types of images applicable include three-dimensional motion contrast data, two-dimensional OCT images, and three-dimensional OCT images acquired by OCT devices. Other examples of the other types of images applicable include fundus images acquired by a fundus camera and scanning laser ophthalmoscope (SLO) images acquired by an SLO.

As another example, OCTA images and the foregoing other types of images may be combined. Specifically, for example, a fundus image that is a three-channel red, green, blue (RGB) color image and an OCTA image that is a one-channel grayscale image can be combined into a four-channel image. Here, the fundus image and the OCTA image can be matched in anatomical position, and anatomical alignment processing is thus performed. If the imaging apparatus 10 has both the functions of a fundus camera and an OCT device, the anatomical positions of the acquired fundus image and OCTA image may already be aligned in advance, and therefore anatomical alignment does not need to be performed again.

If the OCTA images are replaced with the foregoing other types of images, the “OCTA images” described in the foregoing first embodiment are rephrased with the “other types of images”. Consequently, FA examination image-like pseudo images (contrast-enhanced images) of moving image format depicting temporal changes in contrast effects can be suitably acquired based on the foregoing “other types of images”. FA examination image-like images depicting contrast effects corresponding to a contrast duration including contrast times when the operator wants to conduct observation can thus be acquired, and the operator's diagnostic decision-making can be assisted.

### Second Embodiment

Next, a second embodiment will be described. In the following description of the second embodiment, items common to the first embodiment will be omitted, and differences from the foregoing first embodiment will be described.

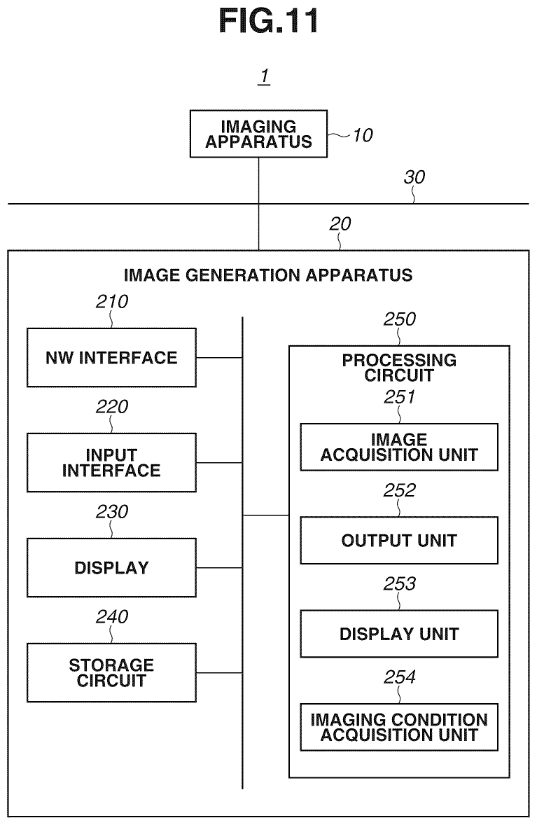

FIG. 11 is a diagram illustrating an example of a schematic configuration of an image generation system 1 including an image generation apparatus 20 according to the second embodiment. In FIG. 11, components similar to those illustrated in FIG. 1 are denoted by the same reference numerals. A detailed description thereof will be omitted.

Compared to the image generation apparatus 20 according to the first embodiment illustrated in FIG. 1, the image generation apparatus 20 according to the second embodiment illustrated in FIG. 11 is configured so that an imaging condition acquisition unit 254 is added to the processing circuit 250.

The imaging condition acquisition unit 254 has a function of acquiring imaging conditions that include a contrast duration including at least one contrast time.

The output unit 252 initially generates an extraction-specific contrast-enhanced image that is a moving image depicting contrast effects corresponding to a contrast duration including a plurality of contrast times, based on a medical image that is a still image acquired by the image acquisition unit 251 as in the first embodiment. The output unit 252 further extracts moving image frames corresponding to the contrast duration included in the imaging conditions acquired by the imaging condition acquisition unit 254 from the moving image frames constituting the extraction-specific contrast-enhanced image, and outputs the extracted moving image frames as a final contrast-enhanced image. Specifically, the contrast-enhanced image according to the present embodiment is an FA examination image-like pseudo contrast image of still image format depicting contrast effects at a specified contrast time, as would be acquired in FA examination. For ease of understanding, suppose here that the imaging condition acquisition unit 254 according to the present embodiment acquires only information about a contrast time as the imaging conditions.

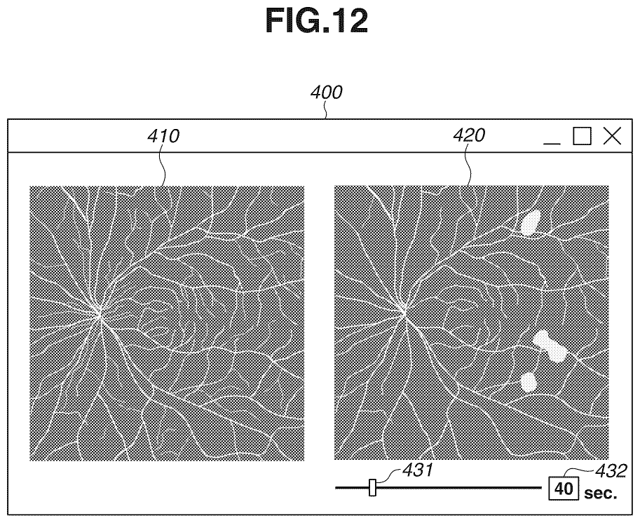

FIG. 12 is a diagram illustrating an example of a GUI screen 400 displayed on the display 230 of the image generation apparatus 20 according to the second embodiment. In FIG. 12, components similar to those illustrated in FIG. 5 are denoted by the same reference numerals. A detailed description thereof will be omitted.

The GUI screen 400 according to the second embodiment illustrated in FIG. 12 is mainly configured so that a contrast time specification slider 431 and a contrast time specification textbox 432 are added to the configuration of the GUI screen 400 according to the first embodiment illustrated in FIG. 5.

The contrast time set as an imaging condition can be specified, for example, by the operator operating the contrast time specification slider 431 or the contrast time specification textbox 432 illustrated in FIG. 12 via the input interface 220. FIG. 12 illustrates an example where a time “40 sec” after the reference point in time is specified as the contrast time. The method for specifying the contrast time is not limited thereto, and may be replaced with other methods that can achieve a similar purpose. While the GUI screen 400 for the operator to specify the contrast time is described here, a contrast time previously determined in the image generation system 1 according to the second embodiment may be input.

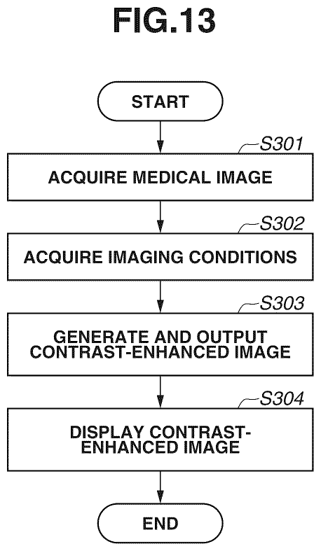

FIG. 13 is a flowchart illustrating an example of a processing procedure for a control method of the image generation apparatus 20 according to the second embodiment.

When the processing of the flowchart illustrated in FIG. 13 is started, in step S301, the image acquisition unit 251 initially acquires an OCTA image that is a medical image from the imaging apparatus 10, for example.

In step S302, the imaging condition acquisition unit 254 acquires imaging conditions that include a contrast duration including at least one contrast time. Specifically, in the present embodiment, the imaging condition acquisition unit 254 acquires a contrast time as the imaging conditions.

In step S303, the output unit 252 generates a contrast-enhanced image depicting contrast effects corresponding to the contrast time based on the OCTA image acquired in step S301 and the imaging conditions (contrast time) acquired in step S302, and outputs the contrast-enhanced image. Specifically, in the present embodiment, the output unit 252 outputs a contrast-enhanced image that is an FA examination image-like pseudo contrast image of still image format depicting contrast effects corresponding to the contrast time.

In step S304, the display unit 253 displays the OCTA image acquired in step S301 in the image display area 410 of the GUI screen 400 illustrated in FIG. 12, and displays the contrast-enhanced image output in step S303 in the image display area 420.

Once the processing of step S304 ends, the processing of the flowchart illustrated in FIG. 13 ends.

As described above, in the image generation apparatus 20 according to the second embodiment, the image acquisition unit 251 acquires an OCTA image that is a medical image from the imaging apparatus 10, for example. The imaging condition acquisition unit 254 acquires the imaging conditions that include a contrast duration including at least one contrast time. The output unit 252 then outputs a contrast-enhanced image depicting contrast effects corresponding to the contrast duration based on the OCTA image acquired by the image acquisition unit 251 and the imaging conditions acquired by the imaging condition acquisition unit 254.

With such a configuration, an image depicting contrast effects corresponding to the contrast period including a specific contrast time (in the present embodiment, the contrast time) can be suitably acquired. More specifically, the image generation apparatus 20 according to the second embodiment can suitably acquire an FA examination image-like image depicting contrast effects corresponding to the contrast time when the operator wants to conduct observation, and can assist the operator's diagnostic decision-making.

### Third Embodiment

Next, a third embodiment will be described. In the following description of the third embodiment, items common to the foregoing first and second embodiments will be omitted, and differences from the foregoing first and second embodiments will be described.

An image generation system including an image generation apparatus according to the third embodiment has a schematic configuration similar to that of the image generation system 1 including the image generation apparatus 20 according to the second embodiment illustrated in FIG. 11.

The output unit 252 of the third embodiment outputs a contrast-enhanced image that is a still image depicting contrast effects corresponding to a contrast time included in the imaging condition acquired by the imaging condition acquisition unit 254 based on a medical image that is a still image acquired by the image acquisition unit 251.

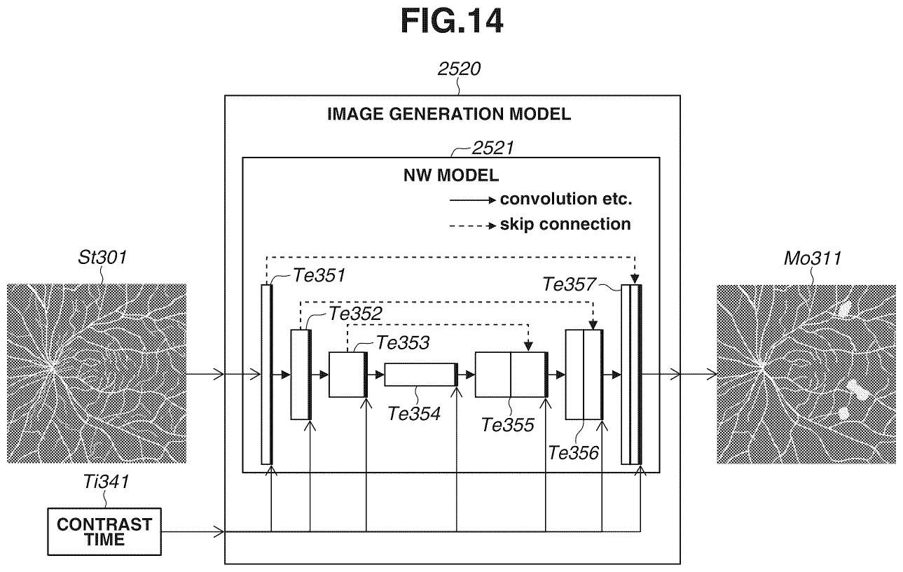

FIG. 14 is a diagram for describing a concept of the image generation model 2520 included in the output unit 252 of the image generation apparatus 20 according to the third embodiment. In FIG. 14, components similar to those illustrated in FIG. 2 are denoted by the same reference numerals. A detailed description thereof will be omitted.

The output unit 252 of the third embodiment includes the image generation model 2520 illustrated in FIG. 14. The image generation model 2520 illustrated in FIG. 14 includes the U-Net-based NW model 2521 as an image processing system using deep learning techniques. While U-Net is described in the present embodiment, other NW models that can achieve a similar purpose may be employed.

The image generation model 2520 of FIG. 14 inputs an input image St301 that is a medical still image and a contrast time Ti341, and generates a contrast-enhanced image that is a still image depicting contrast effects corresponding to the contrast time Ti341 based on the input image St301. Specifically, the image generation model 2520 of FIG. 14 tensorizes the input image St301 that is a still image, tensorizes the contrast time Ti341, and inputs the resulting tensors to the NW model 2521. The image generation model 2520 of FIG. 14 then converts the tensor output by the NW model 2521 into a still image and outputs the still image as an output image Mo311. In other words, by inputting a medical image and at least one contrast time as the input data of the image generation model 2520 that generates a contrast-enhanced image, the output unit 252 can output at least one contrast-enhanced image as the output data of the image generation model 2520. Moreover, by inputting a medical image and a plurality of contrast times as the input data of the image generation model 2520 that generates a contrast-enhanced image, the output unit 252 can output a plurality of contrast-enhanced images corresponding to the respective contrast times as the output data of the image generation model 2520.

In the case of employing U-Net for the NW model 2521, the U-Net needs to be modified. Specifically, a scalar value T representing the contrast time Ti341 is assigned to at least one spatial axis among the number of channels, height, and width of at least one of the tensors generated in the intermediate layers of the NW model 2521. The “tensors generated in the intermediate layers” here correspond to tensors Te351 to Te357 in FIG. 14. While in FIG. 14 the scalar value T is assigned to all the tensors Te351 to Te357, other configurations can be employed, such as where the scalar value Tis assigned to only the tensor Te351 and where the scalar value T is assigned to the tensors Te355 to Te357.

The scalar value T is a scalar value determined based on the contrast time Ti341. An example of the scalar value T is the contrast value Ti341 in units of milliseconds, divided by a constant. For a specific method of assignment, suppose that a tensor before the assignment of the scalar value T has a shape of “B×C×H×W”, for example. Here, B is a minibatch size, C the number of channels, H the height, and W the width. This shape is extended in the number of channels to a shape of “B×(C+1)×H×W”, and processing is added to fill the extended tensor space with the scalar value T. The structure of the NW model 2521 is also modified so that the extended tensor can be processed. Alternatively, if the number of channels is two or more, the tensor space for any one of the channels may be filled with the scalar value T instead of tensor extension. To improve the image generation accuracy (plausibility of the output image Mo311) and calculation efficiency of the image generation model 2520, a NW model 2521 that handles normalized input and output tensors may be used. For example, there may be cases where a large value compared to the generated tensor range of the NW model 2521 (such as −10.0 to 10.0), such as 40000, which indicates 40000 milliseconds, is set as the scalar value T representing the contrast time Ti341. In such cases, the scalar value T may be normalized since a model with low image generation accuracy might otherwise be trained. For example, values may be divided by the maximum possible input value of the image generation model 2520 into values of 0 to 1.

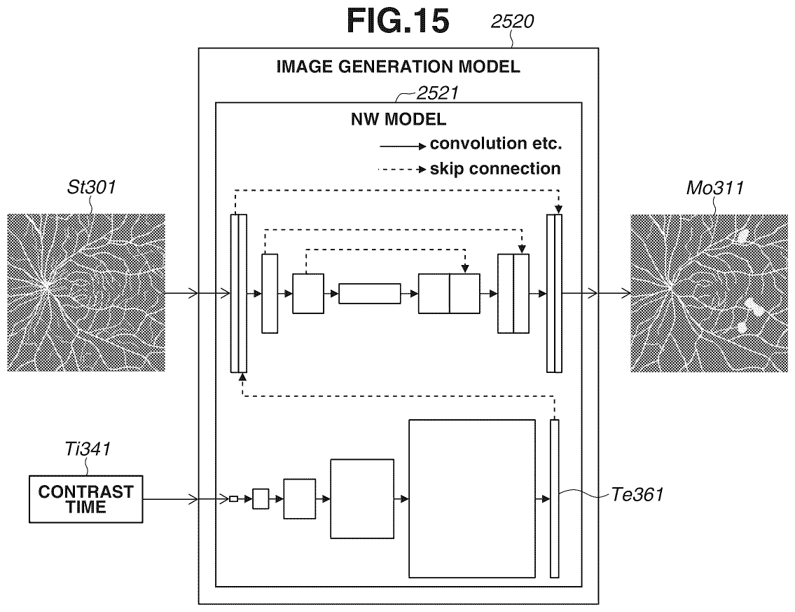

The tensor operations described with reference to FIG. 14 are aimed at inputting information about the contrast time to the image generation model 2520 and having the NW model 2521 process the OCTA image that is the input image St301 and the contrast time Ti341. The present embodiment is therefore not limited to the method described with reference to FIG. 14. Another example of the method will now be described with reference to FIG. 15.

FIG. 15 is a diagram for describing another concept of the image generation model 2520 included in the output unit 252 of the image generation apparatus 20 according to the third embodiment. In FIG. 15, components similar to those illustrated in FIGS. 2 and 14 are denoted by the same reference numerals. A detailed description thereof will be omitted.

For example, another approach may be employed to construct the NW model 2521 with an unmodified U-Net and a conventional decoder NW as illustrated in FIG. 15. Specifically, the scalar value T representing the contrast time Ti341 is initially input to the decoder NW. An upsampled tensor Te361 output from the decoder NW is then concatenated with the OCTA image input to the U-Net, and the U-Net outputs the tensor of the contrast-enhanced image. Even with this configuration illustrated in FIG. 15, the contrast-enhanced image serving as the output image Mo311 can be acquired from the image generation model 2520 by having the NW model 2521 process the OCTA image that is the input image St301 and the contrast time Ti341.

Through the foregoing tensor operations, the information about the contrast time Ti341 can be input to the NW model 2521, and the image generation model 2520 can output a contrast-enhanced image that is a still image depicting contrast effects corresponding to the given contrast time. Note that the method for inputting the information about the contrast time Ti341 to the NW model 2521 is not limited to those described in the present embodiment, and other methods that can achieve a similar purpose may be used. For example, methods such as manipulating the pixel values of the input image St301 with values related to the contrast time Ti341, or adding a new image channel to the input image St301 and setting pixel values relates to the contrast time Ti341, can be applied. Furthermore, a method of inputting an additional image generated based on the contrast time Ti341 to the NW model 2521 can also be applied.

The dataset for training the image generation model 2520 including the foregoing U-Net-based NW model 2521 will now be described. The dataset is configured as a teaching data group acquired from a plurality of examination targets, with an OCTA image that is a still image and an FA examination image captured at a contrast time, which are obtained by capturing the same examination target, and the contrast time of the FA examination image as a set (pair) of teaching data. In the present embodiment, the examination targets are eyes to be examined. For one OCTA image, there may be a plurality of FA examination images (contrast images) captured over time and contrast times (imaging condition groups) corresponding to the FA examination image groups.

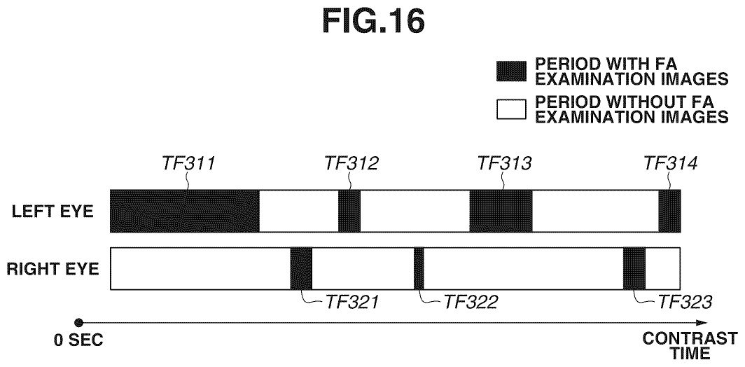

FIG. 16 is a diagram illustrating the third embodiment, illustrating an example of periods with and without left-and right-eye FA examination images that constitute the teaching data used in training the image generation model 2520. FA examination is performed by alternately capturing images of the left and right eyes after injection of the contrast agent. The time frames where the FA examination images exist may therefore have a distribution such as illustrated in FIG. 16. Of these time frames, longer ones such as a time frame TF 311 can be where a moving image is captured as an FA examination image. In the present embodiment, when a moving image is acquired, the moving image frames constituting the moving image may be extracted as still images, contrast times corresponding to the respective moving image frames may be identified, and these may be paired with an OCTA image of the corresponding eye to be executed and used as teaching data.

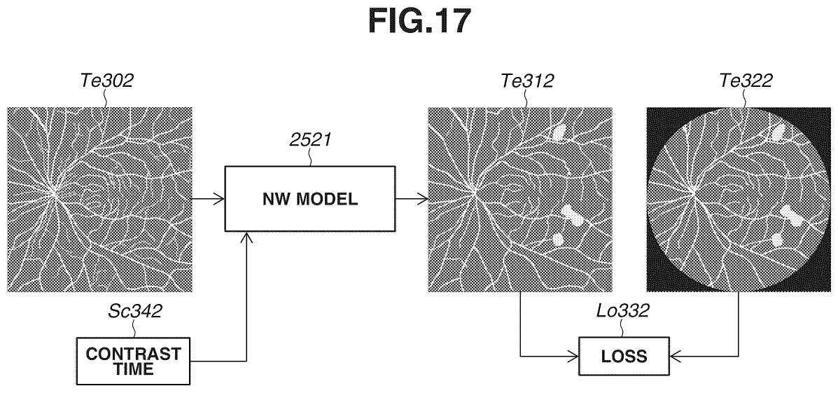

FIG. 17 is a diagram for describing the training of the image generation model 2520 included in the output unit 252 of the image generation apparatus 20 according to the third embodiment. In FIG. 17, components similar to those illustrated in FIGS. 14 and 15 are denoted by the same reference numerals. A detailed description thereof will be omitted. The training of the image generation model 2520 using a set of teaching data, i.e., processing for updating the parameters constituting the NW model 2521 included in the image generation model 2520 will now be described with reference to FIG. 17.

In FIG. 17, an input tensor Te302 obtained by tensorizing the OCTA image constituting the teaching data and a scalar value Se342 representing the contrast time Ti341 constituting the same teaching data are initially input to the NW model 2521. The NW model 2521 outputs an output tensor Te312 corresponding to a contrast-enhanced image that is a still image. The image generation model 2520 then calculates a loss Lo332 that is the error between a ground truth tensor Te322 obtained by tensorizing the FA examination image captured at the contrast time Ti341, which is a still image constituting the same teaching data, and the output tensor Te312. Finally, the image generation model 2520 updates the parameters constituting the NW model 2521 so that the loss Lo332 decreases. This series of update processes is repeated using the teaching data group assigned for training in the dataset, until the NW model 2521 is sufficiently trained.

The image generation model 2520 trained by such processing, when an OCTA image is input, can output a contrast-enhanced image that is a still image depicting plausible contrast effects based on the teaching data group assigned for training in the dataset. More specifically, the image generation model 2520 can output an FA examination image-like pseudo image (contrast-enhanced image) of still image format depicting contrast effects corresponding to the specified contrast time, as would be acquired in FA examination.

A processing procedure for a control method of the image generation apparatus 20 according to the third embodiment is similar to the flowchart illustrating the processing procedure for the control method of the image generation apparatus 20 according to the second embodiment illustrated in FIG. 13. The processing procedure for the control method of the image generation apparatus 20 according to the third embodiment will now be described with reference to the flowchart illustrated in FIG. 13.

In the third embodiment, when the processing of the flowchart illustrated in FIG. 13 is started, in step S301, the image acquisition unit 251 initially acquires an OCTA image that is a medical image from the imaging apparatus 10, for example.

In step S302, the imaging condition acquisition unit 254 acquires imaging conditions that include a contrast duration including at least one contrast time. Specifically, in the present embodiment, the imaging condition acquisition unit 254 acquires a contrast time as the imaging conditions.

In step S303, the output unit 252 generates a contrast-enhanced image depicting contrast effects corresponding to the contrast time based on the OCTA image acquired in step S301 and the imaging conditions (contrast time) acquired in step S302, and outputs the contrast-enhanced image. Specifically, in the present embodiment, the output unit 252 outputs a contrast-enhanced image that is an FA examination image-like pseudo contrast image of still image format depicting contrast effects corresponding to the contrast time.

In step S304, the display unit 253 displays the OCTA image acquired in step S301 in the image display area 410 of the GUI screen 400 illustrated in FIG. 12, and displays the contrast-enhanced image output in step S303 in the image display area 420.

Once the processing of step S304 ends, the processing of the flowchart illustrated in FIG. 13 ends.

As described above, in the image generation apparatus 20 according to the third embodiment, the image acquisition unit 251 acquires an OCTA image that is a medical image from the imaging apparatus 10, for example. The imaging condition acquisition unit 254 acquires imaging conditions that include a contrast duration including at least one contrast time. The output unit 252 outputs a contrast-enhanced image depicting contrast effects corresponding to the contrast duration based on the OCTA image acquired by the image acquisition unit 251 and the imaging conditions acquired by the imaging condition acquisition unit 254.

With such a configuration, an image depicting contrast effects corresponding to the contrast duration including a contrast time (in the present embodiment, the contrast time) can be suitably acquired. More specifically, the image generation apparatus 20 according to the third embodiment can suitably acquire an FA examination image-like image depicting contrast effects corresponding to the contrast time when the operator wants to conduct observation, and can assist the operator's diagnostic decision-making.

Compared to the image generation apparatus 20 according to the first embodiment, the image generation apparatus 20 according to the third embodiment, has low temporal costs and computational costs consumed by the output unit 252 since the output unit 252 does not output moving images, and is thus useful in environments with limited performance. Moreover, the training of the image generation model 2520 included in the output unit 252 does not need teaching data that is moving images covering predetermined contrast time periods (contrast durations). In other words, FA examination images included in the teaching data can be ones captured at respective different contrast times. This facilitates the collection of the teaching data, and can accordingly increase the possibility of depicting contrast effects more closely resembling actual contrast images.

### First Modification of Third Embodiment

Next, a first modification of the foregoing third embodiment will be described as a modification of the third embodiment.

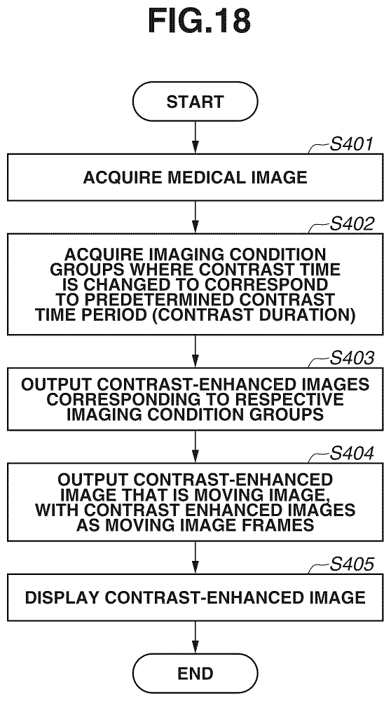

FIG. 18 is a flowchart illustrating an example of a processing procedure for a control method of the image generation apparatus 20 according to the first modification of the third embodiment. The processing of this flowchart illustrated in FIG. 18 enables output of a contrast-enhanced image of moving image format.

When the processing of the flowchart illustrated in FIG. 18 is started, in step S401, the image acquisition unit 251 initially acquires a medical image from the imaging apparatus 10, for example. In the first modification of the third embodiment, the image acquisition unit 251 acquires an OCTA image as the medical image.

In step S402, the imaging condition acquisition unit 254 acquires imaging condition groups in which the contrast time is changed to correspond to a predetermined contrast time period (contrast duration). For example, in the case of observing contrast effects during a predetermined contrast time period (contrast duration) of “from 0 sec to 200 sec” at intervals of 1 sec, the imaging condition acquisition unit 254 acquires 201 image condition groups (contrast times) generated by changing the contrast time like 1 sec, 2 sec, . . . , 200 sec.

In step S403, the output unit 252 outputs contrast-enhanced images corresponding to the respective imaging condition groups (contrast times) acquired in step S402, based on the OCTA image acquired in step S401. Specifically, in step S403, contrast-enhanced images that are FA examination image-like pseudo contrast images of still image format depicting contrast effects corresponding to the respective contrast times are output.

In step S404, the output unit 252 outputs a contrast-enhanced image that is a moving image, with the contrast-enhanced images output in step S403 as moving image frames.

In step S405, the display unit 253 displays the OCTA image acquired in step S401 in the image display area 410 of the GUI screen 400 illustrated in FIG. 5, and displays the contrast-enhanced image that is a moving image output in step S404 in the image display area 420.

Once the processing of step S405 ends, the processing of the flowchart illustrated in FIG. 18 ends.

According to the first modification of the third embodiment, an FA examination image-like image (contrast-enhanced image) of moving image format depicting temporal changes in contrast effects can be suitably acquired based on an OCTA image. An FA examination image-like image depicting contrast effects corresponding to a contrast duration including contrast times when the operator wants to conduct observation can thus be suitably acquired, and the operator's diagnostic decision-making can be assisted.

### Second Modification of Third Embodiment

Next, a second modification of the foregoing third embodiment will be described as a modification of the third embodiment.

The FA examination images constituting the dataset for training the image generation model 2520 according to the foregoing third embodiment may be replaced with other types of images that indicate contrast effects on the examination targets.

Examples of the other types of images applicable include region segmentation images depicting the leakage ranges of the contrast agent found from FA examination images acquired at specific contrast times, contour images of the leakage ranges, and FA examination images colored using a color lookup table.

According to the second modification of the third embodiment, the foregoing other types of images can be suitably acquired as contrast-enhanced images depicting contrast effects corresponding to contrast times based on an OCTA image. Images that indicate contrast effects corresponding to contrast times when the operator wants to conduct observation can thus be suitably obtained, and the operator's diagnostic decision-making can be assisted.

### Third Modification of Third Embodiment

Next, a third modification of the foregoing third embodiment will be described as a modification of the third embodiment.

For the FA examination images constituting the dataset for training the image generation model 2520 according to the third embodiment, interpolated FA images generated by interpolating a plurality of FA examination images acquired by capturing the same examination target over time may be employed. More specifically, as illustrated in FIG. 16, FA examination may include “periods without FA examination images” that are period when no FA examination image is acquired. Generating images corresponding to FA examination images in such “periods without FA examination images” by interpolation processing and employing the interpolated FA examination images improve the image generation accuracy of the image generation model 2520 (the plausibility of depiction of contrast-enhanced images).

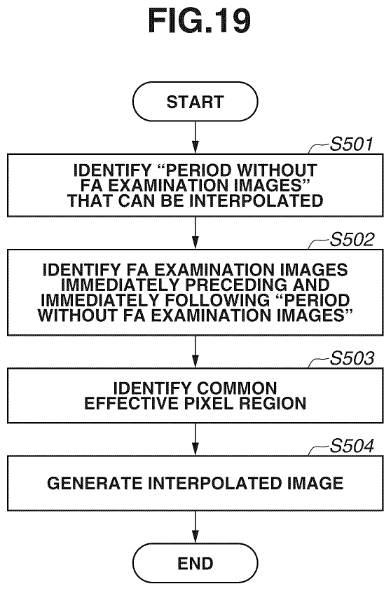

FIG. 19 is a flowchart illustrating the third modification of the third embodiment, illustrating an example of a processing procedure for interpolated image generation processing.

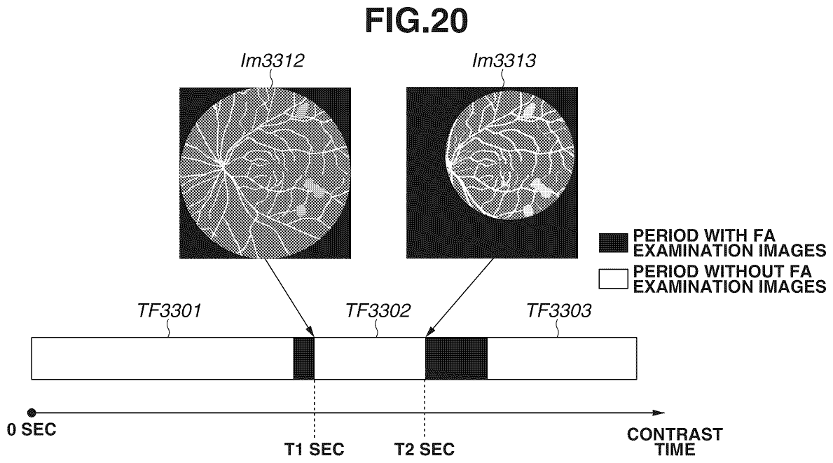

When the processing of the flowchart illustrated in FIG. 19 is started, in step S501, the image generation model 2520 initially identifies a “period without FA examination images” that can be interpolated. A “period without FA examination images” that can be interpolated refers to one immediately preceded and immediately followed by FA examination images. FIG. 20 is a diagram illustrating the third modification of the third embodiment, illustrating an example of periods with and without FA examination images constituting the teaching data used in training the image generation model 2520. In FIG. 20, a time frame TF3302 (contrast times of T1 sec to T2 sec) is a “period without FA examination images” that can be interpolated, identified in step S501.

Return to the description of FIG. 19.

Once the processing of step S501 ends, the processing proceeds to step S502.

In step S502, the image generation model 2520 identifies the FA examination images immediately preceding and immediately following the “period without FA examination images” that can be interpolated, identified in step S501. In the example illustrated in FIG. 20, an immediately preceding FA examination image Im3312 and an immediately following FA examination image Im3313 are identified in step S502.

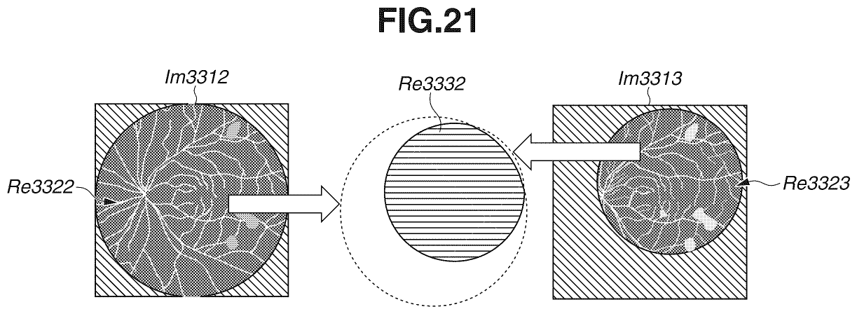

In step S503, the image generation model 2520 identifies an effective pixel region common to the immediately preceding and immediately following FA examination images identified in step S502. As employed herein, an effective pixel region refers to a pixel region where contrast effects are depicted. FIG. 21 is a diagram illustrating the third modification of the third embodiment and intended to describe an effective pixel region Re3332 common to the immediately preceding FA examination image Im3312 and immediately following FA examination image Im3313 illustrated in FIG. 20. In FIG. 21, for example, the masked region around the immediately preceding FA examination image Im3312 is not an effective pixel region since there is no contrast effect depicted. The central non-masked region is an effective pixel region Re3322 since there are contrast effects depicted. An effective pixel region Re3323 of the immediately following FA examination image Im3313 can be similarly identified. In the example illustrated in FIG. 21, the area where the effective pixel region Re3322 of the immediately preceding FA examination image Im3312 and the effective pixel region Re3323 of the immediately following FA examination image Im3313 overlap is the common effective pixel region Re3332 identified in step S503.

Return to the description of FIG. 19.

Once the processing of step S503 ends, the processing proceeds to step S504.

In step S504, the image generation model 2520 generates an interpolated image. Specifically, the image generation model 2520 generates the interpolated image using the pixel values of the immediately preceding FA examination image Im3312 within the common effective pixel region Re3332 and the pixel values of the immediately following FA examination image Im3313 within the common effective pixel region Re3332. In the example illustrated in FIG. 20, the FA examination image in the “period without FA examination images (time frame TF3302)” at contrast times of T1 sec to T2 sec is linearly interpolated to generate the interpolated image.

Specifically, in step S504 of FIG. 19, the image generation model 2520 generates the interpolated image by performing the following processing.

Assume that the pixel value of the immediately preceding FA examination image Im3312 at pixel coordinates (x, y) is Aᵢⱼ, and the pixel value of the immediately following FA examination image Im3313 at pixel coordinates (x, y) is Bᵢⱼ. The pixel value Iᵢⱼ of the interpolated image at pixel coordinates (x, y) at t sec is given by the following Eq. (1):

$${I}_{i j} = ( 1 - α ) \times {A}_{i j} + α \times {B}_{i j} , \qquad ( 1 )$$

$$where$$

$$α = t \div ( T 2 - T 1 ) .$$

All the regions other than the common effective pixel region Re3332 are applied a pixel value to be handled as a masked region, such as 0.

Once the processing of step S504 ends, the processing of the flowchart illustrated in FIG. 19 ends. The interpolated image generation processing of the flowchart illustrated in FIG. 19 enables operations such as generating an interpolated image for the time frame TF3302 that is a “period without FA examination images” in FIG. 20 at intervals of 1 sec and adding the interpolated image to the dataset.

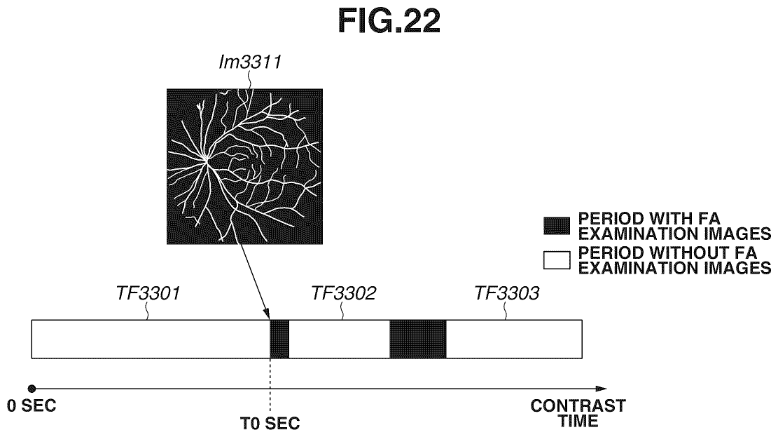

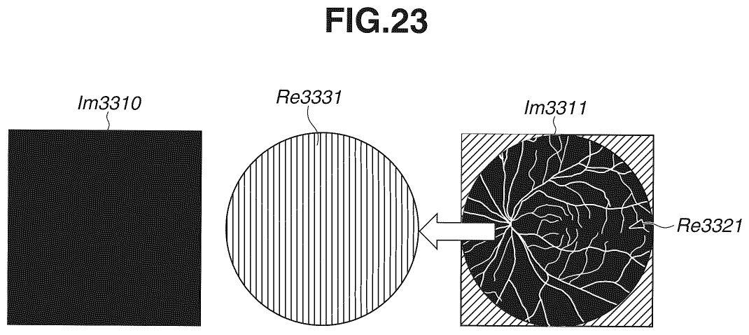

Further application examples will be described with reference to FIGS. 22 and 23.

FIG. 22 is a diagram illustrating the third modification of the third embodiment, illustrating an example of periods with and without FA examination images constituting the teaching data used in training the image generation model 2520. FIG. 23 is a diagram illustrating the third modification of the third embodiment and intended to describe an effective pixel region Re3331 in a case where an immediately preceding FA examination image Im3311 illustrated in FIG. 22 is the first FA exemption image captured in the FA examination. In FIG. 22, suppose that the FA examination image Im3311 immediately following a time frame TF 3301 that is a “period without FA examination image” is the first FA examination image captured in the FA examination. In this case, as illustrated in FIG. 23, an FA examination image Im3310 that is a completely dark image (for example, an image filled with the same pixel value as the masked region) and where the entire image is the effective pixel region may be set as the FA examination image at a contrast time of 0 sec in FIG. 22. Specifically, the FA examination image Im3310 illustrated in FIG. 23 may be set as a virtual FA examination image immediately preceding the “period without FA examination images”. In the example illustrated in FIG. 23, an effective pixel region Re3331 common to the virtual immediately preceding FA examination image Im3310 and the immediately following FA examination image Im3311 is the same as an effective pixel region Re3321 of the immediately following FA examination image Im3311.

According to the third modification of the third embodiment, FA examination images during “periods without FA examination images” are interpolated to augment the teaching data in the dataset. This is effective in improving the image generation accuracy of the image generation model 2520 (the plausibility of depiction of contrast-enhanced images). Images depicting contrast effects corresponding to contrast times when the operator wants to conduct observation can thus be suitably acquired, and the operator's diagnostic decision-making can be assisted.

### Fourth Embodiment

Next, a fourth embodiment will be described. In the following description of the fourth embodiment, items common to the foregoing first to third embodiments will be omitted, and differences from the foregoing first to third embodiments will be described.

An image generation system including an image generation apparatus according to the fourth embodiment has a schematic configuration similar to that of the image generation system 1 including the image generation apparatus 20 according to the first embodiment illustrated in FIG. 1.

The output unit 252 of the fourth embodiment outputs contrast-enhanced images that are still images depicting contrast effects corresponding to a contrast duration including a plurality of predetermined contrast times based on a medical image that is a still image acquired by the image acquisition unit 251.

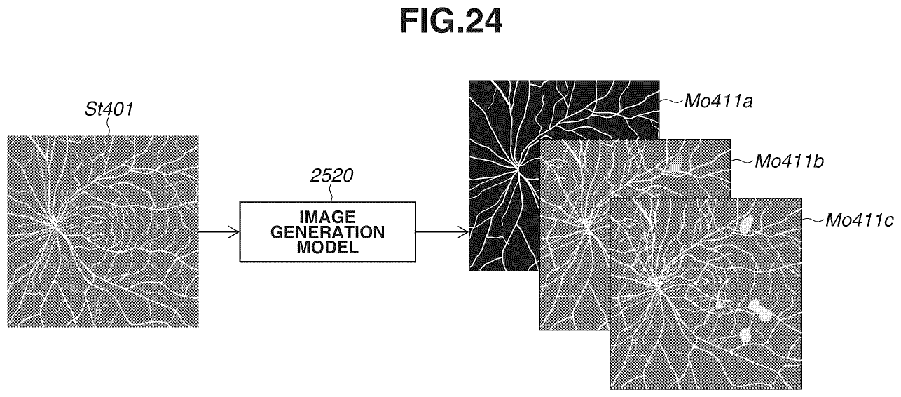

FIG. 24 is a diagram for describing the concept of the image generation model 2520 included in the output unit 252 of the image generation apparatus 20 according to the fourth embodiment. In FIG. 24, components similar to those illustrated in FIG. 2 are denoted by the same reference numerals. A detailed description thereof will be omitted.

The output unit 252 of the fourth embodiment includes the image generation model 2520 illustrated in FIG. 24. The image generation model 2520 illustrated in FIG. 24 includes an image processing system using deep learning techniques.

The image generation model 2520 illustrated in FIG. 24 inputs an input image St401 corresponding to a medical image that is a still image. The image generation model 2520 illustrated in FIG. 24 then outputs, based on the input image St401, output images Mo411a to Mo411c as contrast-enhanced images that are still images depicting contrast effects corresponding to respective predetermined contrast times.

The image generation model 2520 illustrated in FIG. 24 includes a U-Net-based NW model 2521 as the image processing system using deep learning techniques, and outputs contrast-enhanced images depicting contrast effects at N predetermined contrast times. As employed herein, N predetermined contrast times refer to a set of contrast times such as “30 sec, 60 sec, and 200 sec” after a reference point in time. The predetermined contrast times here can be clinically useful contrast times. For example, the predetermined contrast times may be selected from contrast times such as “within 60 sec (early contrast phase)”, “60 to 200 sec (mid contrast phase)”, and “200 sec or more (late contrast phase)” after the reference point in time.

The image generation model 2520 illustrated in FIG. 24 tensorizes the input image St401 that is a still image and inputs the tensor to the NW model (2521). The image generation model 2520 illustrated in FIG. 24 then converts the tensor output by the NW model (2521) into still images and outputs the still images as the output images Mo411a to Mo411c. If U-Net is employed for the NW model (2521), the U-Net needs to be modified.

Specific examples will now be described. Suppose that the tensor of the input image St401 that is a still image has the shape of “Cᵢₙ×Hᵢₙ×Wᵢₙ” described in the foregoing first embodiment. The NW model (2521) that is the modified U-Net increases the number of elements constituting the input tensor, performs shape transformation before the final layer, and outputs a tensor shaped “N×Cₒᵤₜ×Hₒᵤₜ×Wₒᵤₜ”. The tensor output from the NW model (2521) is divided into N tensors shaped “Cₒᵤₜ×Hₒᵤₜ×Wₒᵤₜ”. The divided tensors are then converted into respective still images, and the output images Mo411a to Mo411c are output from the image generation model 2520 as contrast-enhanced images. The tensor shapes are not limited to those described in the present embodiment, and other shapes that can achieve a similar purpose may be used. While U-Net is described in the present embodiment, other NW models that can achieve a similar purpose may be employed.

The dataset for training the image generation model 2520 illustrated in FIG. 24, including the U-Net-based NW model (2521) will now be described. The dataset is configured as a teaching data group acquired from a plurality of examination targets, with an OCTA image that is a still image and an FA examination image or images that are obtained at one or more contrast times among N predetermined contrast times, which are obtained by capturing the same examination target, as a set (pair) of teaching data. In the present embodiment, the examination targets are eyes to be examined.

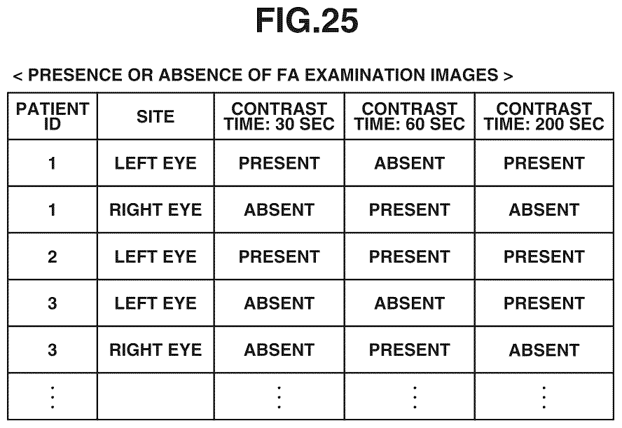

For clarity of description, three times, namely, “30 sec, 60 sec, and 200 sec” after the reference point in time will hereinafter be assumed as the N predetermined contrast times. FIG. 25 is a chart illustrating the fourth embodiment and intended to describe the presence or absence of FA examination images constituting the teaching data used in training the image generation model 2520. As described in the third embodiment with reference to FIG. 16, FA examination may include time frames when imaging is unable to be performed. FIG. 25 illustrates an example of possible collection patterns of FA examination images constituting the teaching data.

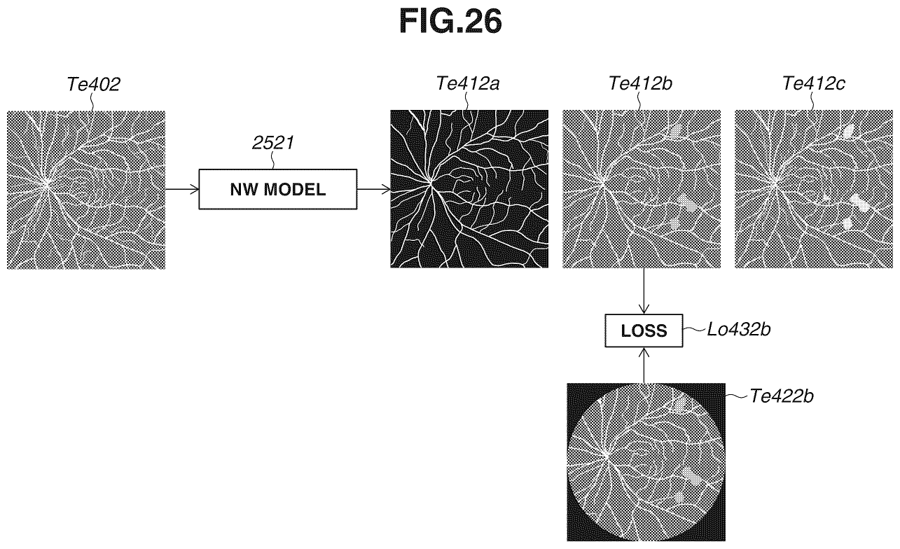

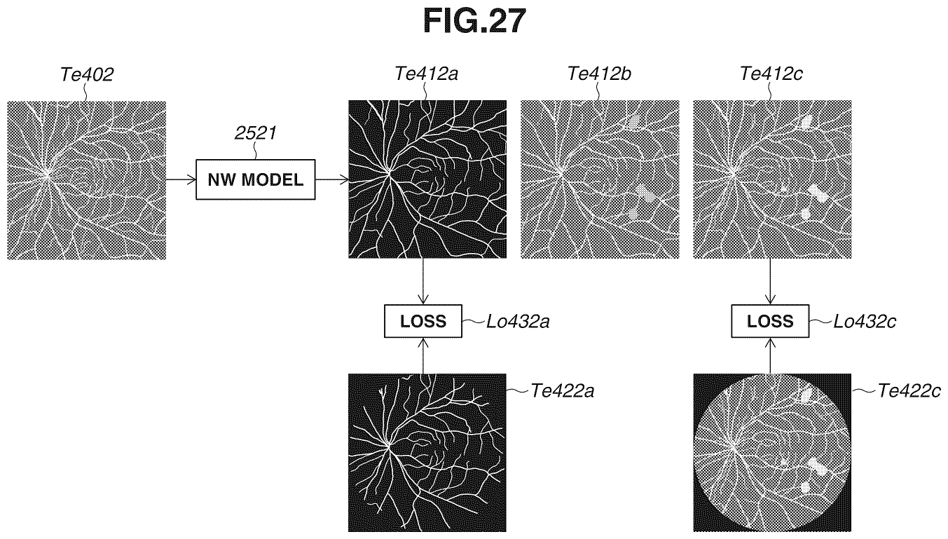

FIGS. 26 and 27 are diagrams for describing the training of the image generation model 2520 included in the output unit 252 of the image generation apparatus 20 according to the fourth embodiment. In the present embodiment, the image generation model 2520 included in the output unit 252 includes the NW model 2521 illustrated in FIGS. 26 and 27. The training of the image generation model 2520 using a set of teaching data, i.e., processing for updating the parameters constituting the NW model 2521 included in the image generation model 2520 will now be described with reference to FIGS. 26 and 27.

Initially, in FIG. 26, an input tensor Te402 obtained by tensorizing an OCTA image constituting the teaching data is input to the NW model 2521. The NW model 2521 outputs output tensors Te412a to Te412c equivalent to three contrast-enhanced images that are still images. Next, the image generation model 2520 calculates losses from FA examination images that are still images constituting the same teaching data except for missing contrast times, and determines a final loss by averaging the losses. For example, if the teaching data includes only an FA examination image at a contrast time of 60 sec, the processing illustrated in FIG. 26 is performed. In this case, as illustrated in FIG. 26, a loss Lo432b that is the error between a ground truth tensor Te422b obtained by tensorizing the FA examination image at a contrast time of 60 sec and the corresponding output tensor Te412b is calculated as the final loss. Suppose, as another pattern, that the teaching data includes only two FA examination images, one at a contrast time of 30 sec and one at a contrast time of 200 sec. In such a case, the processing illustrated in FIG. 27 is performed. More specifically, in this case, as illustrated in FIG. 27, losses Lo432a and Lo432c related to a contrast time of 30 sec and 60 sec are similarly calculated, and their average (Lo432a+Lo432c)/2 is calculated as the final loss. Finally, the image generation model 2520 updates the parameters constituting the NW model 2521 so that the final loss decreases. This series of update processes is repeated using the teaching data group assigned for training in the dataset, until the NW model 2521 is sufficiently trained.

The image generation model 2520 trained by the foregoing processing, when an OCTA image is input, can output contrast-enhanced images that are a plurality of still images depicting plausible contrast effects based on the teaching data group assigned for training in the dataset. Specifically, the image generation model 2520 can output contrast-enhanced images that are three still images depicting plausible contrast effects corresponding to contrast times of 30 sec, 60 sec, and 200 sec. In other words, the image generation model 2520 can output FA examination image-like pseudo contrast images (contrast-enhanced images) of still image format depicting contrast effects at the three contrast times, as would be acquired in FA examination.

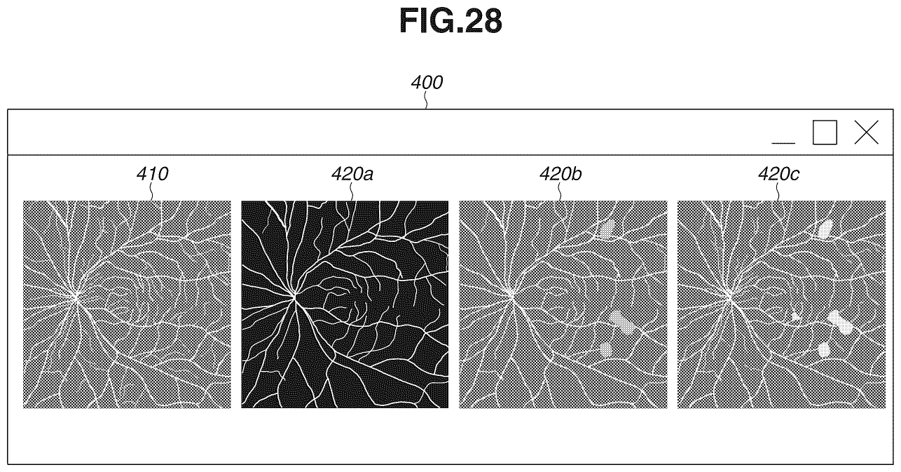

FIG. 28 is a diagram illustrating an example of the GUI screen 400 displayed on the display 230 of the image generation apparatus 20 according to the fourth embodiment.

The display unit 253 performs processing for displaying the GUI screen 400 illustrated in FIG. 28 on the display 230. Specifically, the display unit 253 performs processing for displaying the medical image (in the present embodiment, OCTA image) acquired by the image acquisition unit 251 in the image display area 410 of the GUI screen 400 illustrated in FIG. 28. The display unit 253 also performs processing for displaying the three contrast-enhanced images output from the output unit 252 in image display areas 420a to 420c of the GUI screen 400 illustrated in FIG. 28. In the present embodiment, the contrast-enhanced image corresponding to a contrast time of 30 sec is displayed in the image display area 420a, the contrast-enhanced image corresponding to a contrast time of 60 sec is displayed in the image display area 420b, and the contrast-enhanced image corresponding to a contrast time of 200 sec is displayed in the image display area 420c. The operator can thus observe the contrast-enhanced images corresponding to the respective contrast times by visually observing the image display areas 420a to 420c of the GUI screen 400.

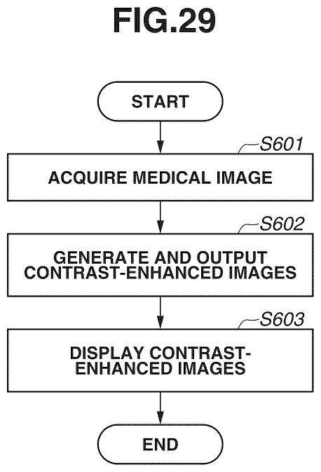

FIG. 29 is a flowchart illustrating an example of a processing procedure for a control method of the image generation apparatus 20 according to the fourth embodiment.

When the processing of the flowchart illustrated in FIG. 29 is started, in step S601, the image acquisition unit 251 initially acquires an OCTA image that is a medical image from the imaging apparatus 10, for example.

In step S602, the output unit 252 generates contrast-enhanced images depicting contrast effects corresponding to a contrast duration including a plurality of predetermined contrast times based on the OCTA image acquired in step S601. Specifically, in the present embodiment, the output unit 252 outputs contrast-enhanced images that are FA examination image-like pseudo contrast images of still image format depicting contrast effects corresponding to the plurality of predetermined contrast times.

In step S603, the display unit 253 displays the OCTA image acquired in step S601 in the image display area 410 of the GUI screen 400 illustrated in FIG. 28, and displays the contrast-enhanced images output in step S602 in the image display areas 420a to 420c. In other words, as in the GUI screen 400 illustrated in FIG. 28, the OCTA image acquired in step S601 and the contrast-enhanced images output in step S602 are displayed side by side.

Once the processing of step S603 ends, the processing of the flowchart illustrated in FIG. 29 ends.

As described above, in the image generation apparatus 20 according to the fourth embodiment, the image acquisition unit 251 acquires an OCTA image that is a medical image from the imaging apparatus 10, for example. The output unit 252 then outputs contrast-enhanced image (FA examination image-like pseudo contrast images of still image format) depicting contrast effects corresponding to a plurality of contrast times based on the OCTA image acquired by the image acquisition unit 251.

With such a configuration, images depicting contrast effects corresponding to a contrast duration including a plurality of contrast times can be suitably acquired. As a result, FA examination image-like images depicting contrast effects corresponding to contrast times when the operator wants to conduct observation can be suitably acquired, and the operator's diagnostic decision-making can be assisted. Moreover, unlike the case of outputting a contrast-enhanced image of moving image format, the image generation apparatus 20 according to the fourth embodiment enables simultaneous observation of contrast-enhanced images at diagnostically useful contrast times, with high temporal efficiency. The image generation apparatus 20 according to the fourth embodiment also reduces the burden of generating the dataset since only images related to the contrast times when the operator wants to conduct observation need to be collected as teaching data.

### Modification of Fourth Embodiment

Next, a modification of the foregoing fourth embodiment will be described.

The output unit 252 of the fourth embodiment may include a plurality of image generation models 2520, and each image generation model 2520 may output an FA examination image-like pseudo contrast-enhanced image of still image format depicting contrast effects corresponding to a contrast time among a plurality of contrast times. In other words, in the modification of the fourth embodiment, each of the plurality of image generation models 2520 is configured to input an OCTA image and output a contrast-enhanced image corresponding to a contrast time.

### Fifth Embodiment

Next, a fifth embodiment will be described. In the following description of the fifth embodiment, items common to the foregoing first to fourth embodiments will be omitted, and differences from the foregoing first to fourth embodiments will be described.

An image generation system including an image generation apparatus according to the fifth embodiment has a schematic configuration similar to that of the image generation system 1 including the image generation apparatus 20 according to the second embodiment illustrated in FIG. 11.

The fifth embodiment is configured so that the imaging conditions acquired by the imaging condition acquisition unit 254 include other conditions in addition to a contrast duration including contrast times, and the other conditions included in the imaging conditions can affect contrast-enhanced images for the output unit 252 to output. The other conditions included in the imaging conditions include one or more pieces of information related to FA examination, such as the presence or absence of individual image processing (optional image quality enhancement processing) of FA examination images, the imaging angle of view of FA examination images, subject information (sex, age, imaging site, the presence or absence of treatment, etc.), and the model of the FA examination device.

The imaging condition acquisition unit 254 of the fifth embodiment acquires the imaging conditions that include the other conditions including one or more pieces of the foregoing FA examination-related information, in addition to a contrast duration including at least one contrast time. In other words, the imaging condition acquisition unit 254 of the fifth embodiment acquires the imaging conditions that include the foregoing contrast duration and the information different from and other than the contrast duration. The output unit 252 of the fifth embodiment outputs a contrast-enhanced image that is a still image depicting contrast effects based on the medical image that is a still image acquired by the image acquisition unit 251 and the imaging conditions acquired by the imaging condition acquisition unit 254. In doing so, the medical image and the imaging conditions, namely, the contrast duration and the information other than the contrast duration are input to the image generation model 2520 included in the output unit 252.

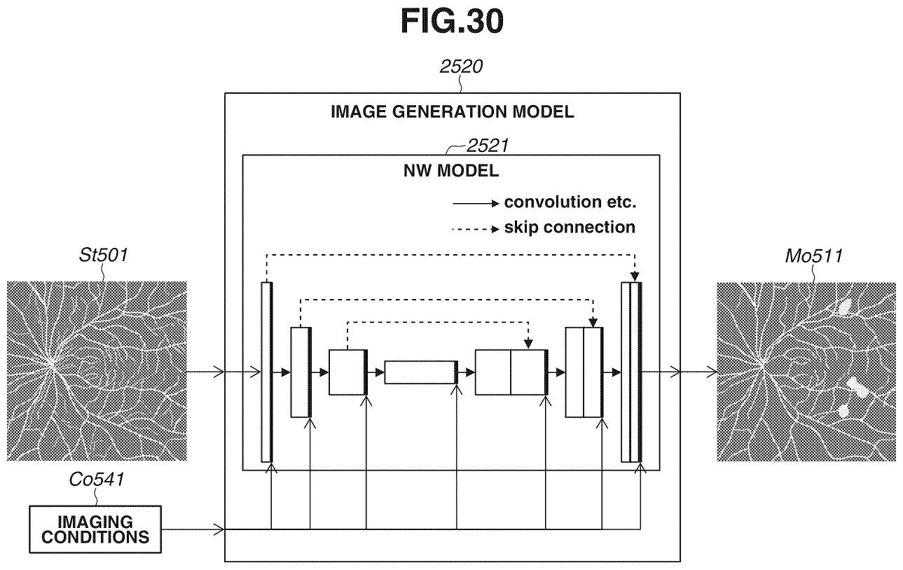

FIG. 30 is a diagram for describing the concept of the image generation model 2520 included in the output unit 252 of the image generation apparatus 20 according to the fifth embodiment. In FIG. 30, components similar to those illustrated in FIGS. 2, 14, and 15 are denoted by the same reference numerals. A detailed description thereof will be omitted.

The output unit 252 of the fifth embodiment includes the image generation model 2520 illustrated in FIG. 30. The image generation model 2520 illustrated in FIG. 30 includes a U-Net-based NW model 2521 as its image processing system using deep learning techniques. While U-Net is described in the present embodiment, other NW models that can achieve a similar purpose can be employed.

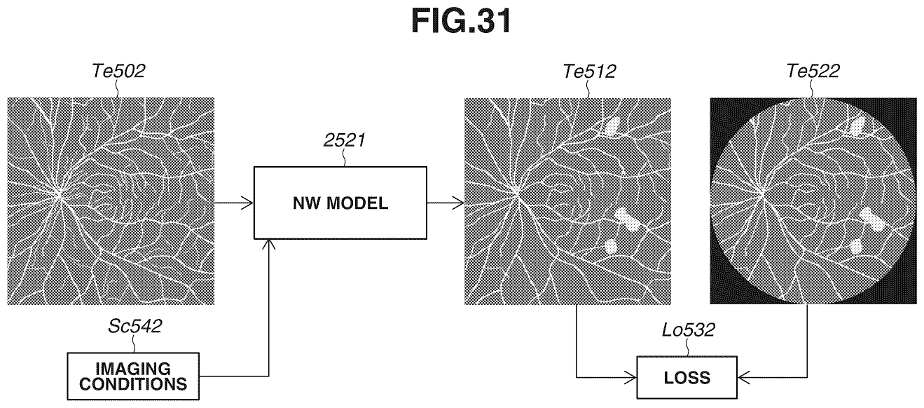

FIG. 31 is a diagram for describing the training of the image generation model 2520 included in the image generation apparatus 20 according to the fifth embodiment. In FIG. 31, components similar to those illustrated in FIG. 30 are denoted by the same reference numerals. A detailed description thereof will be omitted.

The image generation model 2520 illustrated in FIG. 30 inputs an input image St501 corresponding to a medical image that is a still image and imaging conditions Co541, and generates a contrast-enhanced image that is a still image depicting contrast effects based on the input image St501. Specifically, the image generation model 2520 of FIG. 30 inputs an input tensor Te502 of FIG. 31 obtained by tensorizing the input image St501 of FIG. 30 and the tensor (Sc542) of the imaging conditions Co541 of FIG. 30 to the NW model 2521. The image generation model 2520 of FIG. 30 converts the tensor output by the NW model 2521 into a still image and outputs the resulting output image Mo511 as a contrast-enhanced image.

When U-Net is employed as the NW model 2521, the U-Net needs to be modified. The modification method is similar to that of the third embodiment but with some differences. The differences from the third embodiment will now be described.

Specifically, a scalar value group Sc542 representing the imaging conditions Co541 is assigned to at least one of the tensor spatial axes, namely, the number of channels, height, and width of at least one tensor generated in the intermediate layers of the NW model 2521. Here, the scalar value group Sc542 is a set of scalar values determined based on the FA examination-related information group constituting the imaging conditions Co541. For example, information expressed by continuous values, such as contrast time and age, is converted into scalar values divided by constants as in the third embodiment. Information that can be expressed by Boolean values, such as the presence or absence of individual image processing and the presence or absence of treatment, is converted into scalar values with false as 0 and true as 1, for example. Information that can be expressed as categories, such as sex, imaging site, the imaging angle of view (30°, 55°, etc.), and the model of the FA examination device, is converted into scalar values obtained by dividing the corresponding category values by constants, for example. As a specific example, suppose that sex information is expressed by category values of 0 for male, 1 for female, and 2 for unknown or others. In such a case, the category values may be divided by a constant of 2, the maximum value of the category values, into scalar values of 0, 0.5, and 1, respectively. Since the purpose is to input the FA examination-related information group to the NW model 2521, the scalar value conversion does not necessarily need to be performed in exactly the manner described above. Take, for example, the case where age information is included as FA examination-related information. While ages are described to be handled as continuous values in the foregoing example of scalar value conversion, they may be categorized as discrete values. Alternatively, ages may be handled as age groups, and converted into scalar values based on category values corresponding to “20s”, “30s”, “40s”, etc. As an example of a specific assignment method, suppose that the original tensor before the assignment of the scalar value group Sc542 has a shape of “B×C×H×W”, and the number of pieces of information included in the imaging conditions Co541 (i.e., the number of scalar values constituting the scalar value group Sc542) is M. In such a case, the number of channels is extended to shape “B×(C+M)×H×W”. The channel regions in the extended tensor region are then filled with the respective scalar values constituting the scalar value group Sc542, and the structure of the NW model 2521 is modified so that the extended tensor can be processed. Alternatively, if the number of channels is (M+1) or more, the tensor regions of any M channels may be filled with the respective scalar values constituting the scalar value group Sc542 instead of tensor extension. Since the purpose is to input the FA examination-related information group to the NW model 2521, the scalar value group Sc542 does not necessarily need to be input to the NW model 2521 in exactly the manner described above. For example, the scalar values constituting the scalar value group Sc542 may be assigned to respective different tensors among those generated in the intermediate layers of the NW model 2521.

Now, the dataset for training the image generation model 2520 including the foregoing U-Net-based NW model 2521 will be described. The dataset is configured as a teaching data group acquired from a plurality of examination targets, with an OCTA image that is a still image and an FA examination image, which are obtained by capturing the same examination target, and imaging conditions including at least a contrast time of the FA examination image as a set (pair) of teaching data. In the present embodiment, the examination targets are eyes to be examined. Hereinafter, the training of the image generation model 2520 using a set of training data, i.e., processing for updating the parameters constituting the NW model 2521 included in the image generation model 2520 will be described with reference to FIG. 31.

In FIG. 31, an input tensor Te502 obtained by tensorizing the OCTA image constituting the teaching data and a scalar value group Sc542 representing the imaging conditions Co541 constituting the same teaching data are initially input to the NW model 2521. The NW model 2521 outputs an output tensor Te512 corresponding to a contrast-enhanced image that is a still image. The image generation model 2520 then calculates a loss Lo532 that is the error between a ground truth tensor Te522 obtained by tensorizing the FA examination image that is a still image constituting the same teaching data and the output sensor Te512. Finally, the image generation model 2520 updates the parameters constituting the NW model 2521 so that the loss Lo532 decreases. This series of update processes is repeated using the teaching data group assigned for training in the dataset, until the NW model 2521 is sufficiently trained.

The image generation model 2520 trained by the foregoing processing, when an OCTA image is input, can output a contrast-enhanced image that is a still image depicting plausible contrast effects based on the teaching data group assigned for training in the dataset. In other words, the image generation model 2520 can output an FA examination image-like pseudo contrast image (contrast-enhanced image) of still image format depicting contrast effects corresponding to the specified contrast time, as would be acquired in FA examination.

A processing procedure for a control method of the image generation apparatus 20 according to the fifth embodiment is similar to the flowchart illustrating the processing procedure for the control method of the image generation apparatus 20 according to the second embodiment illustrated in FIG. 13. The processing procedure for the control method of the image generation apparatus 20 according to the fifth embodiment will now be described with reference to the flowchart illustrated in FIG. 13.

In the fifth embodiment, when the processing of the flowchart illustrated in FIG. 13 is started, in step S301, the image acquisition unit 251 initially acquires an OCTA image that is a medical image from the imaging apparatus 10, for example.

In step S302, the imaging condition acquisition unit 254 acquires imaging conditions that include a contrast duration including at least one contrast time and information other than the contrast duration.

In step S303, the output unit 252 generates a contrast-enhanced image depicting contrast effects based on the OCTA image acquired in step S301 and the imaging conditions acquired in step S302, and outputs the contrast-enhanced image. Specifically, in the present embodiment, the output unit 252 outputs a contrast-enhanced image that is an FA examination image-like pseudo contrast image of still image format depicting the contrast effects.

In step S304, the display unit 253 displays the OCTA image acquired in step S301 in the image display area 410 of the GUI screen 400 illustrated in FIG. 12, and displays the contrast-enhanced image output in step S303 in the image display area 420.

Once the processing of step S304 ends, the processing of the flowchart illustrated in FIG. 13 ends.

As described above, in the image generation apparatus 20 according to the fifth embodiment, the image acquisition unit 251 acquires an OCTA image that is a medical image from the imaging apparatus 10, for example. The imaging condition acquisition unit 254 acquires imaging conditions that include a contrast duration including at least one contrast time and information other than the contrast duration. The output unit 252 then outputs a contrast-enhanced image (FA examination image-like pseudo image of still image format) depicting contrast effects based on the OCTA image acquired by the image acquisition unit 251 and the imaging conditions acquired by the imaging condition acquisition unit 254.

With such a configuration, an FA examination image-like image depicting contrast effects corresponding to a contrast time when the operator wants to conduct observation can be suitably acquired, and the operator's diagnostic decision-making can be assisted. Moreover, unlike the third embodiment, the image generation apparatus 20 according to the fifth embodiment can affect the contrast-enhanced image depending on the information other than the contrast duration, i.e., the other conditions included in the imaging conditions.

### Modification of Fifth Embodiment

Next, a modification of the foregoing fifth embodiment will be described.

The imaging condition acquisition unit 254 according to the foregoing fifth embodiment may be configured to acquire OCTA examination-related information in addition to the FA examination-related information. Moreover, the teaching data may also be configured to include OCTA examination-related information. As employed herein, OCTA examination-related information includes the model of the OCTA examination device, the presence or absence of individual image processing on OCTA images, the depth range for OCTA image generation (superficial layer, deep layer, outer layer, choroidal vascular NW, etc.), and the imaging angle of view of OCTA images. The OCTA examination-related information further includes the resolution of OCTA images and the scan mode (cross, radial) of OCTA images.

According to the modification of the fifth embodiment, the OCTA examination-related information can further be reflected in the image generation processing by the image generation apparatus 20, and a contrast-enhanced image depicting contrast effects based on more detailed features of the input OCTA image can be acquired. As a result, contrast-enhanced images depicting contrast effects corresponding to a contrast duration including contrast times when the operator wants to conduct observation can be suitably obtained, and the operator's diagnostic decision-making can be assisted.

### Sixth Embodiment

Next, a sixth embodiment will be described. In the following description of the sixth embodiment, items common to the foregoing first to fifth embodiments will be omitted, and differences from the foregoing first to fifth embodiments will be described.

An image generation system including an image generation apparatus according to the sixth embodiment has a schematic configuration similar to that of the image generation system 1 including the image generation apparatus 20 according to the second embodiment illustrated in FIG. 11.

The imaging condition acquisition unit 254 of the sixth embodiment acquires imaging conditions that include, in addition to a contrast duration including at least one contrast time, information other than the contrast duration. In the present embodiment, the information other than the contrast duration included in the imaging conditions includes one or more pieces of information that relate to OCTA examination or FA examination and can be interpreted as categories.

The output unit 252 of the sixth embodiment includes an image generation model group including a plurality of image generation models 2520. The image generation models 2520 in the image generation model group are constructed to correspond to respective types of information interpretable as categories included in the imaging conditions acquired by the imaging condition acquisition unit 254, and differ in quality related to the depiction of contrast effects. Suppose, for example, that the imaging conditions include “depth range information (superficial layer, deep layer, outer layer, choroidal vascular NW, etc.)” for OCTA image generation as OCTA examination-related information. In such a case, the output unit 252 includes a plurality of depth range-specific image generation models. Specifically, the image generation model group includes a “superficial layer image generation model”, a “deep layer image generation model”, an “outer layer image generation model”, and a “choroidal vascular NW image generation model”, for example.

The output unit 252 of the sixth embodiment selects an appropriate image generation model 2520 from the plurality of image generation models 2520 based on the information other than the contrast duration included in the imaging conditions. The output unit 252 of the sixth embodiment then outputs a contrast-enhanced image based on the medical image acquired by the image acquisition unit 251 and the imaging conditions acquired by the imaging condition acquisition unit 254, using the selected image generation model 2520. Specifically, the output unit 252 of the sixth embodiment selects an appropriate image generation model 2520 based on the foregoing depth range information included in the imaging conditions, and performs contrast-enhanced image generation processing.

Suppose, for example, that the “presence or absence of individual image processing (optional image quality enhancement processing etc.)” is included in the imaging conditions as FA examination-related information. In such a case, the output unit 252 includes two image generation models 2520 corresponding to the presence and absence of individual image processing, respectively. Specifically, the two image generation models 2520 are an “image generation model 2520 with individual image processing” and an “image generation model 2520 without individual image processing”. Here, the output unit 252 selects an appropriate image generation model 2520 depending on the presence or absence of individual image processing included in the imaging conditions, and performs the contrast-enhanced image generation processing. In some cases, continuous values included in the imaging conditions can be interpreted as categories. For example, categories such as “before 100 sec”, “100 sec or later and before 200 sec”, and “200 sec or later” may be determined based on the contrast time value. If new category information can be generated from contrast times as in this example, the information included in the imaging conditions may be contrast times alone.

The image generation model group including the plurality of image generation models 2520 includes NW models 2521 that are trained using respective datasets suitable for the imaging conditions used. Specifically, the dataset for training the NW model 2521 to be used when the “depth range information” for OCTA image generation is “superficial layer” is configured as follows: The dataset is a teaching data group obtained from a plurality of examination targets, with an OCTA image that is a still image and generated for the depth range “superficial layer” and an FA examination image, which are obtained by capturing the same examination target, and imaging conditions including at least a contrast time of the FA examination image as a set (pair) of teaching data. In the present embodiment, the examination targets are eyes to be examined.

The imaging condition based on which the image generation model 2520 is selected (hereinafter, image generation model selection-specific imaging condition) does not need to be input to the selected image generation model 2520. The imaging conditions excluding the image generation model selection-specific imaging condition are thus input to the image generation model 2520. In other words, the imaging conditions include a contrast duration including at least one contrast time and other imaging conditions needed by the selected image generation model 2520. For example, the “depth range information” does not need to be input to the “surface layer image generation model” to be used when the foregoing “depth range information” is “superficial layer”. The imaging conditions input to the “superficial layer image generation model” therefore do not include the “depth range information” but include the contrast duration including at least one contrast time.

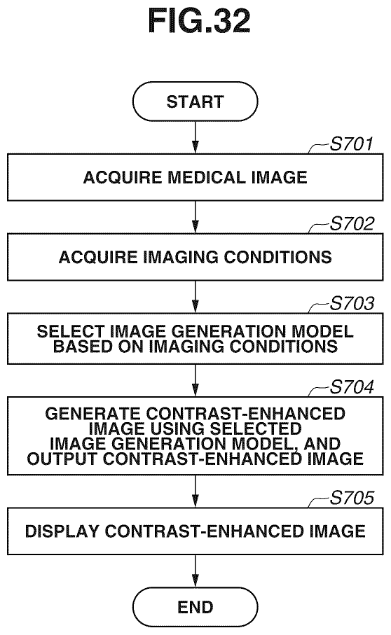

FIG. 32 is a flowchart illustrating an example of a processing procedure for a control method of the image generation apparatus 20 according to the sixth embodiment.

When the processing of the flowchart illustrated in FIG. 32 is started, in step S701, the image acquisition unit 251 initially acquires an OCTA image that is a medical image from the imaging apparatus 10, for example.

In step S702, the imaging condition acquisition unit 254 acquires imaging conditions that include, in addition to a contrast duration including at least one contrast time, information other than the contrast duration. In the present embodiment, the information other than the contrast duration included in the imaging conditions includes one or more pieces of information that relate to OCTA examination or FA examination and can be interpreted as categories.

In step S703, the output unit 252 selects an appropriate image generation model 2520 from the plurality of image generation models 2520 based on the information other than the contrast duration (information interpretable as categories) included in the imaging conditions.

In step S704, the output unit 252 generates a contrast-enhanced image depicting contrast effects based on the OCTA image acquired in step S701, using the image generation model 2520 selected in step S703, and outputs the contrast-enhanced image. Specifically, in the present embodiment, the output unit 252 outputs a contrast-enhanced image that is an FA examination image-like pseudo contrast image of still image format.

In step S705, the display unit 253 displays the OCTA image acquired in step S701 in the image display area 410 of the GUI screen 400 illustrated in FIG. 12, and displays the contrast-enhanced image output in step S704 in the image display area 420.

Once the processing of step S705 ends, the processing of the flowchart illustrated in FIG. 32 ends.

As described above, in the image generation apparatus 20 according to the sixth embodiment, the image acquisition unit 251 acquires an OCTA image that is a medical image from the imaging apparatus 10, for example. The imaging condition acquisition unit 254 acquires the imaging conditions that include, in addition to a contrast duration including at least one contrast time, information other than the contrast duration. The output unit 252 selects an appropriate image generation model 2520 from the plurality of image generation models 2520 based on the information other than the contrast duration (information interpretable as categories) included in the imaging conditions. The output unit 252 then outputs a contrast-enhanced image depicting contrast effects based on the OCTA image acquired by the image acquisition unit 251, using the selected image generation model 2520.

With such a configuration, FA examination image-like images depicting contrast effects corresponding to contrast times when the operator wants to conduct observation can be suitably acquired, and the operator's diagnostic decision-making can be assisted. Moreover, the image generation apparatus 20 according to the sixth embodiment can switch the image generation models 2520 depending on the imaging conditions. This can increase the possibility of acquiring contrast-enhanced images depicting contrast effects more closely resembling actual contrast images.

### First Modification of Sixth Embodiment

Next, a first modification of the sixth embodiment will be described as a modification of the sixth embodiment.

The output unit 252 of the foregoing sixth embodiment includes the image generation model group including a plurality of image generation models 2520, and the following modification can be applied thereto. Specifically, instead of selecting an image generation model 2520 based on the information interpretable as categories included in the imaging conditions, all the image generation models 2520 may output respective contrast-enhanced images. Since the first modification of the sixth embodiment does not involve selection of the image generation models 2520, the foregoing imaging conditions do not need to include the “information interpretable as categories”.

The plurality of contrast-enhanced images output by the plurality of image generation models 2520 can be displayed on the GUI screen 400, or stored in the storage circuit 240 and used for other processing. The plurality of contrast-enhanced images output by the plurality of image generation models 2520 can also be transferred to not-illustrated other devices via the NW interface 210 and the NW 30, and used by the devices.

### Second Modification of Sixth Embodiment

Next, a second modification of the foregoing sixth embodiment will be described as a modification of the sixth embodiment.

The output unit 252 of the foregoing sixth embodiment includes the image generation model group including a plurality of image generation models 2520, and the following modification can be applied thereto. Specifically, instead of including the image generation model group, the output unit 252 may include a single image generation model 2520 that can output contrast-enhanced images corresponding to all the category values defined by the “information interpretable as categories” included in the imaging conditions.

For example, a case where “superficial layer”, “deep layer”, “outer layer”, and “choroidal vascular NW” are defined as category values corresponding to the “depth range information” described in the sixth embodiment will be described. In the second modification of the sixth embodiment, the image generation model 2520 included in the output unit 252 can output contrast-enhanced images for the respective depth ranges “superficial layer”, “deep layer”, “outer layer”, and “choroidal vascular NW”. The image generation processing of the output unit 252 includes outputting the contrast-enhanced images respectively corresponding to the “superficial layer”, “deep layer”, “outer layer”, and “choroidal vascular NW” based on at least a contrast time included in the imaging conditions. Since this example does not involve selection of image generation models 2520, the imaging conditions do not need to include the “depth range information” that is “information interpretable as categories”. Alternatively, the imaging conditions may include the “depth range information”, and the foregoing image generation model 2520 may perform processing to output only the contrast-enhanced image corresponding to the “depth range information”.

### Seventh Embodiment

Next, a seventh embodiment will be described. In the following description of the seventh embodiment, items common to the foregoing first to sixth embodiments will be omitted, and differences from the foregoing first to sixth embodiments will be described.

An image generation system including an image generation apparatus according to the seventh embodiment has a schematic configuration similar to that of the image generation system 1 including the image generation apparatus 20 according to the second embodiment illustrated in FIG. 11.

The output unit 252 of the seventh embodiment, in simple terms, inputs a radiographic image that is a three-dimensional image as a medical image. The output unit 252 of the seventh embodiment then outputs a contrast-enhanced image that is a contrast four-dimensional computed tomography (4DCT) image-like pseudo contrast image of moving image format depicting contrast effects based on the radiographic image.

The image acquisition unit 251 of the seventh embodiment acquires a radiographic image that is a three-dimensional image as a medical image that is a still image acquired by the imaging apparatus 10 capturing the examination target. Specifically, the medical image according to the present embodiment is assumed to be a three-dimensional computed tomography (CT) image. However, other radiographic images acquired by the imaging apparatus 10 may be used. In the present embodiment, the imaging apparatus 10 only need to be capable of acquiring radiographic images. For such a reason, the imaging apparatus 10 may be replaced with an image management system that stores and manages radiographic images, for example.

The output unit 252 of the seventh embodiment includes one or more image generation models 2520. The image generation models 2520 are constructed to correspond to the types of information interpretable as categories included in the imaging conditions acquired by the imaging condition acquisition unit 254, and may differ in quality related to the depiction of contrast effects. For example, suppose that the imaging conditions include “imaging site information (head, chest, abdomen, etc.)” as CT examination-related information. In such situations, the output unit 252 includes an image generation model group including a plurality of image generation models 2520 for respective imaging sites. Specifically, the image generation model group here includes a “head image generation model”, a “chest image generation model”, and an “abdomen image generation model”, for example.

The output unit 252 of the seventh embodiment selects an image generation model 2520 based on the imaging site information included in the imaging conditions, performs image generation processing, and outputs a contrast-enhanced image that is a still image. If a plurality of imaging conditions is specified, the output unit 252 of the seventh embodiment outputs contrast-enhanced images that are a plurality of still images corresponding to the respective imaging conditions. Moreover, the output unit 252 of the seventh embodiment outputs a contrast-enhanced image that is a moving image, with the contrast-enhanced images as moving image frames. The contrast-enhanced image that is the moving image generated here is a three-dimensional moving image, or a contrast 4DCT image-like pseudo contrast image. As an example of interpreting values included in the imaging conditions as categories, categories such as “under 20s”, “20s to 30s”, and “40s and above” may be determined based on the subjects' age values.

The image generation model group including the plurality of image generation models 2520 includes NW models 2521 that are trained using datasets suitable for the respective imaging conditions for use. Specifically, the dataset for training the NW model 2521 to be used when the “imaging site information” is “head” is configured as follows: Specifically, the dataset is a teaching data group acquired from a plurality of subjects, with a CT image and a contrast CT image obtained by capturing the “head” of the same examination target and imaging conditions including at least a contrast time of the contrast CT image as a set (pair) of teaching data.

The imaging condition acquisition unit 254 of the seventh embodiment acquires imaging condition groups where the contrast time is changed to correspond to a predetermined contrast time period (contrast duration). For example, to observe contrast effects during a predetermined contrast time period (contrast duration) of “0 sec to 1000 sec” at intervals of 1 sec, 1001 imaging condition groups (contrast times) generated by changing the contrast time like 1 sec, 2 sec, . . . , 1000 sec are acquired. The imaging conditions may include information interpretable as categories, such as “imaging site information”.

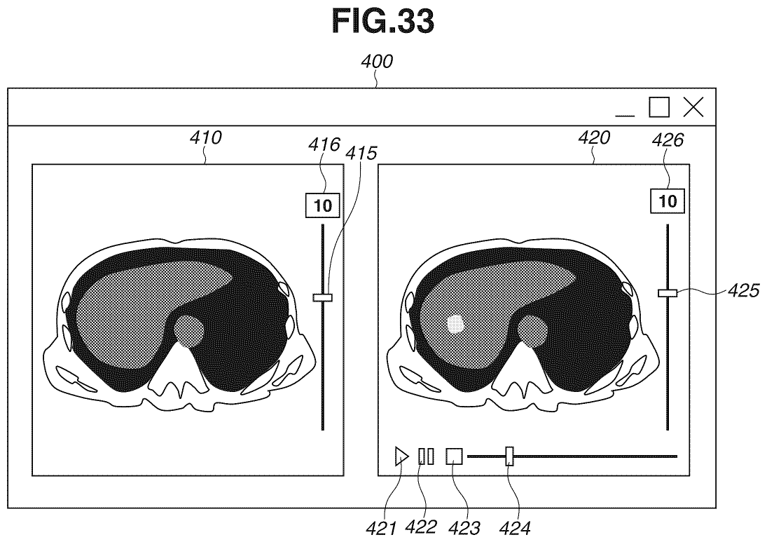

The display unit 253 of the seventh embodiment displays a GUI screen so that the operator can easily observe the contrast-enhanced images output by the output unit 252. FIG. 33 is a diagram illustrating an example of the GUI screen 400 displayed on the display 230 of the image generation apparatus 20 according to the seventh embodiment. In FIG. 33, components similar to those illustrated in FIG. 5 are denoted by the same reference numerals. A detailed description thereof will be omitted. The display unit 253 performs processing for displaying the medical image (in the present embodiment, radiographic image) acquired by the image acquisition unit 251 in the image display area 410 of the GUI screen 400 illustrated in FIG. 33. The display unit 253 also performs processing for displaying the contrast-enhanced image output from the output unit 252 in the image display area 420 of the GUI screen 400 illustrated in FIG. 33. In particular, when the output unit 252 outputs a contrast 4DCT image-like pseudo contrast-enhanced image, the display unit 253 may provide the following display. As illustrated in FIG. 33, the display unit 253 can display a slice position operation slider 425 and its textbox 426 for operating the three-dimensional images, along with the GUI screen components (421 to 424) capable of a playback operation and a seek operation of the moving image. The display unit 253 can similarly display a slider 415 and its textbox 416 in the image display area 410 of the GUI screen 400 illustrated in FIG. 33 as well.

A processing procedure for a control method of the image generation apparatus 20 according to the seventh embodiment is similar to the flowchart illustrating the processing procedure for the control method of the image generation apparatus 20 according to the first modification of the third embodiment illustrated in FIG. 18. The processing procedure for the control method of the image generation apparatus 20 according to the seventh embodiment will now be described with reference to the flowchart illustrated in FIG. 18.

In the seventh embodiment, when the processing of the flowchart illustrated in FIG. 18 is started, in step S401, the image acquisition unit 251 initially acquires a medical image from the imaging apparatus 10, for example. In the seventh embodiment, the image acquisition unit 251 acquires a three-dimensional CT image as the medical image.

In step S402, the imaging condition acquisition unit 254 acquires imaging condition groups (contrast times) where the contrast time is changed to correspond to a predetermined contrast time period (contrast duration).

In step S403, the output unit 252 outputs contrast-enhanced images corresponding to the respective imaging condition groups acquired in step S402 based on the three-dimensional CT image acquired in step S401. Specifically, in step S403, the output unit 252 outputs contrast-enhanced images that are contrast CT image-like pseudo contrast images of still image format depicting contrast effects corresponding to the imaging condition groups (contrast times) acquired in step S402.

In step S404, the output unit 252 outputs a contrast-enhanced image that is a moving image, with the contrast-enhanced images output in step S403 as moving image frames.

In step S405, the display unit 253 displays the CT image acquired in step S401 in the image display area 410 of the GUI screen 400 illustrated in FIG. 33, and displays the contrast-enhanced image that is the moving image output in step S404 in the image display area 420.

Once the processing of step S405 ends, the processing of the flowchart illustrated in FIG. 18 ends.

According to the seventh embodiment, a contrast CT image of moving image format that enables observation of temporal changes in contrast effects, i.e., a contrast 4DCT-like pseudo image (contrast-enhanced image) can be acquired based on a CT image. A contrast 4DCT-like pseudo image corresponding to contrast times when the operator wants to conduct observation can thus be suitably acquired, and the operator's diagnostic decision-making can be assisted.

### Eighth Embodiment

Next, an eighth embodiment will be described. In the following description of the eighth embodiment, items common to the foregoing first to seventh embodiments are omitted, and differences from the foregoing first to seventh embodiments will be described.

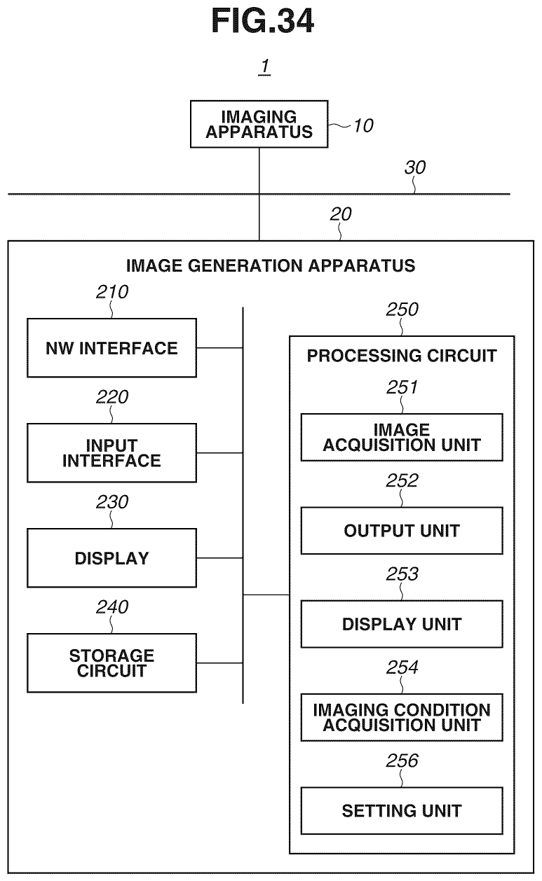

FIG. 34 is a diagram illustrating an example of a schematic configuration of an image generation system 1 including an image generation apparatus 20 according to the eighth embodiment. In FIG. 34, components similar to those illustrated in FIG. 11 are denoted by the same reference numerals. A detailed description thereof will be omitted.

Compared to the configuration of the image generation apparatus 20 according to the second embodiment illustrated in FIG. 11, the image generation apparatus 20 according to the eighth embodiment illustrated in FIG. 34 is configured so that a setting unit 256 is added to the processing circuit 250.

The setting unit 256 has a function of setting at least one moving image generation condition.

The output unit 252 according to the eighth embodiment, like the third embodiment, generates contrast-enhanced images that are still images depicting contrast effects corresponding to contrast times included in the imaging conditions acquired by the imaging condition acquisition unit 254, based on the medical image that is a still image acquired by the image acquisition unit 251.

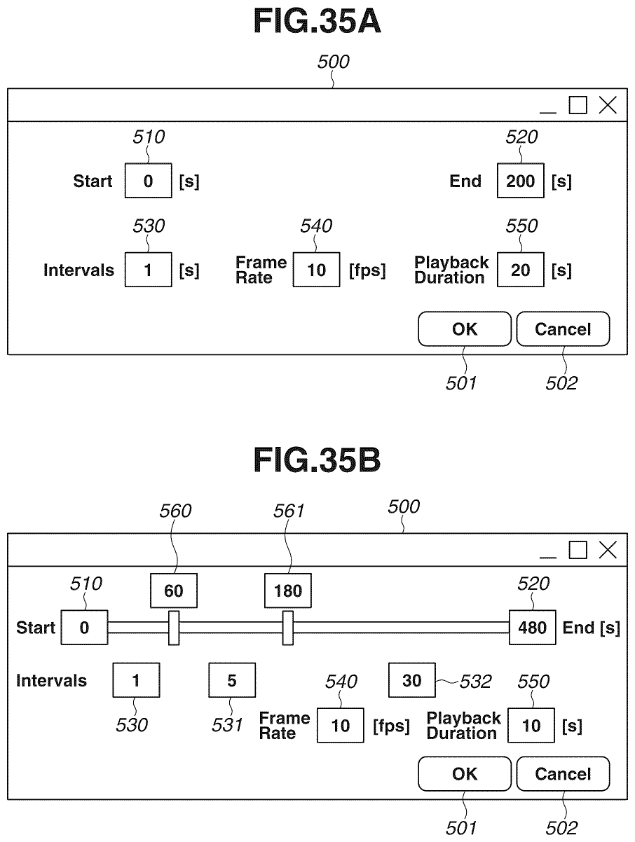

FIGS. 35A and 35B are diagrams illustrating examples of a GUI screen 500 displayed on the display 230 of the image generation apparatus 20 according to the eighth embodiment. The display unit 253 displays the GUI screen 500 for configuring settings about the generation of a contrast-enhanced moving image based on given contrast times such as illustrated in FIGS. 35A and 35B. Operation screens for setting given contrast times will now be described with reference to FIGS. 35A and 35B.

The example of FIG. 35A will initially be described. The GUI screen 500 of FIG. 35A includes a start time section 510, an end time section 520, an interval section 530, a number of images per unit time section 540, a playback duration section 550, an OK button 501, and a cancel button 502. To reflect the numerical values input to the GUI screen 500, the operator presses the OK button 501. To cancel the input numerical values, the operator presses the cancel button 502. If the cancel button 502 is pressed, not-illustrated initial setting values are applied.

The output unit 252 generates contrast-enhanced images for the duration from the start time to the end time set on the GUI screen 500 at intervals set in the interval section 530, and outputs a contrast-enhanced image that is a moving image with the contrast-enhanced images at the number of images per unit time (FPS). Here, by inputting the medical image and a plurality of contrast times as input data of the image generation model 2520 for generating contrast-enhanced images, the output unit 252 can output a plurality of contrast-enhanced images corresponding to the plurality of respective contrast times as output data of the image generation model 2520. Here, the plurality of contrast times may be a plurality of contrast times corresponding to intervals set based on the operator's instructions. In this example, the output unit 252 generates contrast-enhanced images from 0 to 200 sec at intervals of 1 sec and generates a moving image that plays back the contrast-enhanced images at 10 FPS. In other words, a moving image that plays back the duration from 0 to 200 sec in approximately 20 sec is generated. A total playback duration of the moving image is automatically calculated and displayed in the playback duration section 550 based on the numerical values input to the start time section 510, the end time section 520, the interval section 530, and the number of images per unit time section 540. In other words, the output unit 252 may output the plurality of contrast-enhanced images output as the output data of the image generation model 2520 along with the plurality of contrast times. Now, if a numerical value of 1 FPS is set to the number of images per unit time section 540, a moving image that plays back the duration from 0 to 200 sec in approximately 200 sec is generated. Note that the numerical values set in the start time section 510 and the end time section 520 may be in units of minutes instead of seconds, or may be in minutes and seconds. The numerical value set in the interval section 530 does not need to be an integer and may be in steps of 0.1 sec. If the same numerical value is set in the start time section 510 and the end time section 520, the still image at that time may be generated instead of a moving image.

Next, the example of FIG. 35B will be described. With the GUI screen 500 of FIG. 35B, an FA examination image-like pseudo contrast-enhanced image that is a moving image is generated based on the numerical values set in the start time section 510, the end time section 520, interval sections 530 to 532, the number of images per unit time section 540, and division sections 560 and 561. In this example, contrast-enhanced images are generated at intervals of 1 sec from 0 to 60 sec, at intervals of 5 sec from 60 to 180 sec, and at intervals of 30 sec from 180 to 480 sec, and a moving image that plays back the contrast-enhanced images at 10 FPS is generated. In other words, a moving image that plays back the duration from 0 to 480 sec in approximately 10 sec is generated.

In the foregoing example, the entire duration is divided into three periods by two division sections, and a moving image with different time intervals is generated. However, this is not restrictive. The number of division sections can be increased or decreased using not-illustrated operation sections. Periods to not generate pseudo contrast-enhanced images can also be set.

An example where the entire duration is divided into five periods by four division sections will be described. Periods to not generate images may be interposed between periods to generate a pseudo contrast-enhanced moving image, like generate images at intervals of 1 sec from 0 to 120 sec, no images from 120 to 180 sec, generate images at intervals of 5 sec from 180 to 300 sec, no images from 300 to 360 sec, and generate images at intervals of 20 sec from 360 to 480 sec. As a method for setting periods to not generate images, the settings to not generate pseudo contrast-enhanced images in given periods may be configured by inputting 0 as the numerical values in the interval sections, inputting no numerical value, or unchecking not-illustrated checkboxes. FIG. 35B illustrates an example where a moving image is generated with a plurality of divided periods. However, separate moving images may be generated for the respective divided periods. The number of images per unit time may be set for each of the moving images in the respective periods.

While FIGS. 35A and 35B illustrate the GUI screen 500 capable of configuring one type of settings, multiple sets of such settings may be stored. Which contrast times to generate pseudo contrast-enhanced images at may be selected on the GUI screen 400, or may be selected on a not-illustrated setting screen.

The setting unit 256 does not necessarily need to configure settings onscreen. Settings may be configured on a text basis or stored in the storage circuit 240.

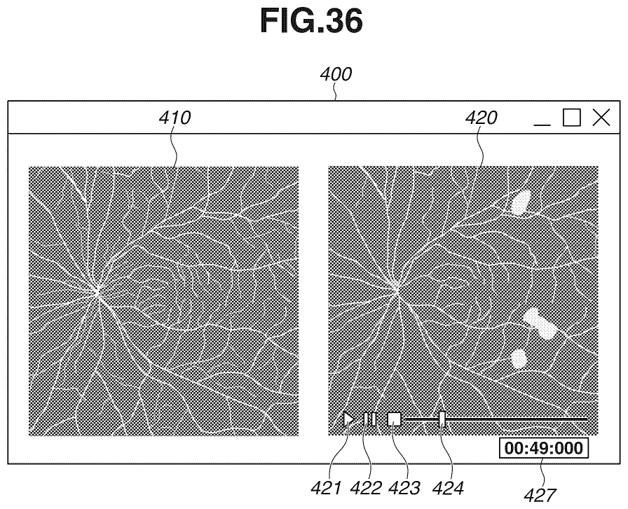

The display unit 253 performs processing for displaying the GUI screen 400 such as illustrated in FIG. 36 on the display 230. The display unit 253 performs processing for displaying the medical image (such as an OCTA image) acquired by the image acquisition unit 251 in the image display area 410 of the GUI screen 400 illustrated in FIG. 36. The image display area 420 of the GUI screen 400 includes operation tools by which the operator can operate the contrast-enhanced image that is a moving image. The image display area 420 includes, as the operation tools, a playback button 421 for starting playback of the moving image, a pause button 422 for pausing the playback of the moving image, a stop button 423 for stopping the playback of the moving image, and a seek bar 424 for changing the playback position of the moving image. The contrast-enhanced image that is the moving image displayed in the image display area 420 may automatically start playing, or may be paused at a playback position corresponding to a diagnostically useful contrast time. The moving image is played back at FPS set in the number of images per unit time section 540 illustrated in FIG. 35A or 35B.

The display unit 253 performs processing for displaying the contrast-enhanced image output from the output unit 252 in the image display area 420 of the GUI screen 400 illustrated in FIG. 36. Here, by inputting the medical image and at least one contrast time as the input data of the image generation model 2520 for generating a contrast-enhanced image, the output unit 252 can output at least one contrast-enhanced image output as output data of the image generation model 2520 along with at least one contrast time. The at least one contrast time here may be at least one contrast time that is set based on the operator's instructions. In performing the processing for displaying the contrast-enhanced image that is a moving image in the image display area 420, the display unit 253 displays, in a contrast time display section 427, the time corresponding to the image in the image display area 420. For example, the contrast time display section 427 provides display in the form of “mm:ss:fff”. Here, mm represents minutes, ss seconds, and fff milliseconds. FIG. 36 illustrates an example where the image 49 seconds after the reference point in time is being displayed. If the moving image is generated at intervals of 1 sec, the contrast time display section 427 is updated to “00:50:000” upon display of the next frame in the image display area 420, and the contrast time display section 427 is updated to “00:51:000” upon the next frame, with the images and times varying synchronously. As illustrated in FIGS. 35A and 35B, the playback duration of the moving image and the duration of the pseudo-generated contrast-enhanced image that is a moving image might not coincide. The operator can comprehend the time of the contrast-enhanced image being displayed in the image display area 420 by visually observing the contrast time display section 427 of the GUI screen 400.

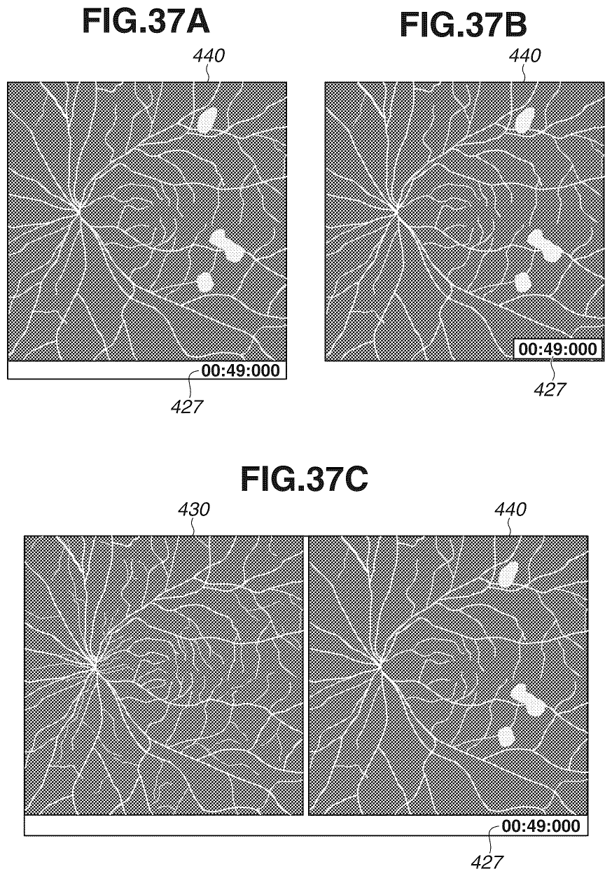

The time information is not limited to situations where the contrast-enhanced image is displayed on the GUI screen 400, and can be stored along with the image when the contrast-enhanced image is stored as a plurality of still images or a moving image in the storage circuit 240 such as a hard disk drive (HDD) and a solid-state drive (SSD). FIGS. 37A to 37C illustrate examples thereof. FIGS. 37A to 37C illustrate examples of one of a plurality of still images or a frame in a moving image. FIG. 37A illustrates an example where a contrast-enhanced image 440 and the contrast time display section 427 indicating the corresponding time are stored in a state where the contrast time display section 427 is displayed under the contrast-enhanced image 440. FIG. 37B illustrates an example where the contrast time display section 427 indicating the corresponding time is superimposed on the contrast-enhanced image 440. FIG. 37C illustrates an example where an OCTA image 430, the contrast-enhanced image 440, and the contrast time display section 427 indicating the corresponding time are stored as a single image (or frame). In the case of storing the images and times as a moving image, the moving image is stored at FPS set in the number of images per unit time section 540.

While the present embodiment has been described using the output unit 252 of the third embodiment as an example, the output unit 252 may extract moving image frames corresponding to contrast times from a moving image as in the second embodiment, and then reconstruct a moving image for playback based on the times set on the GUI screen 500.

As has been described above, in the image generation apparatus 20 according to the eighth embodiment, the image acquisition unit 251 acquires an OCTA image that is a medical image from the imaging apparatus 10, for example. The imaging condition acquisition unit 254 acquires imaging conditions that include a contrast duration including a plurality of contrast times. The output unit 252 then outputs contrast-enhanced images (FA examination image-like pseudo contrast-enhanced images of still image format) depicting contrast effects corresponding to the plurality of contrast times based on the OCTA image acquired by the image acquisition unit 251.

Such a configuration enables the operator to specify generation of contrast-enhanced images at given time intervals in generating the contrast-enhanced images from the still image. Moreover, the operator can suitably comprehend the contrast-enhanced images and contrast times, and the operator's diagnostic decision-making can be assisted.

### Ninth Embodiment

Next, a ninth embodiment will be described. In the following description of the ninth embodiment, items common to the foregoing first to eighth embodiments will be omitted, and differences from the foregoing first to eighth embodiments will be described.

An image generation system including an image generation apparatus according to the ninth embodiment has a schematic configuration similar to that of the image generation system 1 including the image generation apparatus 20 according to the eighth embodiment illustrated in FIG. 34.

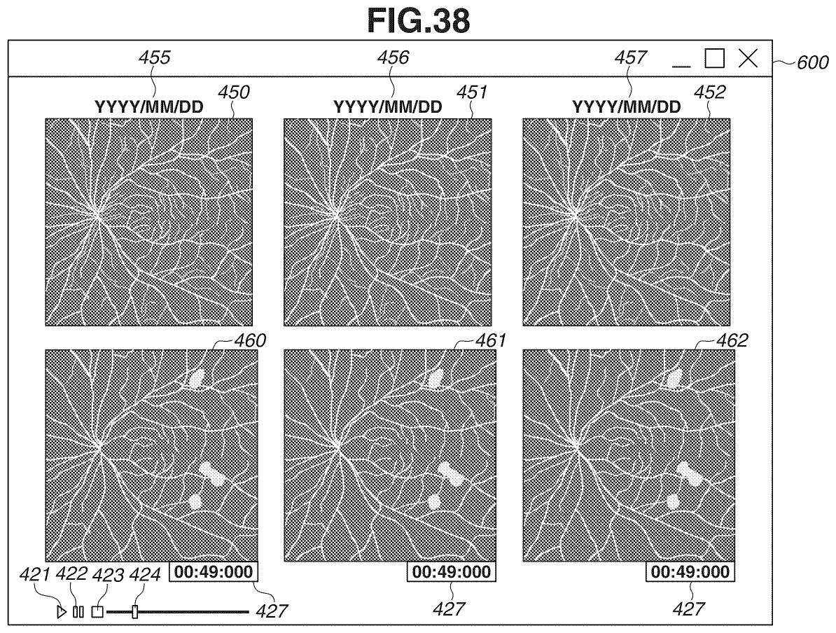

FIG. 38 is a diagram illustrating an example of a GUI screen 600 displayed on the display 230 of the image generation apparatus 20 according to the ninth embodiment. The GUI screen 600 is an example of a screen that displays a plurality of medical images captured at different times (for example, OCTA images of the same eye captured at different dates and times) side by side. The display unit 253 performs processing for displaying the OCTA images acquired by the image acquisition unit 251 in image display areas 450 to 452 of the GUI screen 600 and displaying dates and times 455 to 457 of capture of the OCTA images. The display unit 253 also performs processing for displaying contrast-enhanced images output from the output unit 252 in image display areas 460 to 462.

Specifically, in the example of the GUI screen 600, the date and time 455, the OCTA image displayed in the image display area 450, the contrast-enhanced image displayed in the image display area 460, and the contrast time display section 427 that are displayed in a column constitute a group.

FIG. 38 illustrates an example of displaying a plurality of groups for which the same moving image generation conditions described in the eighth embodiment are set. There are common GUI screen components (421 to 424) capable of moving image playback and seek operations, whereby the plurality of moving images can be synchronously operated. In the case of displaying a plurality of groups for which different moving image generation conditions are set, the GUI screen components (421 to 424) may be provided for each group so that each moving image can be independently operated.

While the contrast-enhanced images displayed in the image display areas 460 to 462 are described to be moving images, this is not restrictive. For example, the contrast-enhanced images may be still images at given times. In such a case, the operator can specify the given times using not-illustrated screen components. The output unit 252 outputs contrast-enhanced images corresponding to the specified contrast times, and displays the contrast-enhanced images in the image display areas 460 to 462.

As described above, in the image generation apparatus 20 according to the ninth embodiment, the image acquisition unit 251 acquires a plurality of OCTA images that are medical images from the imaging apparatus 10, for example. The imaging condition acquisition unit 254 acquires multiple sets of imaging conditions each including a contrast duration including at least one contrast time. The output unit 252 then outputs a plurality of contrast-enhanced images depicting contrast effects corresponding to the contrast times based on the OCTA images acquired by the image acquisition unit 251 and the imaging conditions acquired by the imaging condition acquisition unit 254.

With such a configuration, a plurality of contrast-enhanced images can be simultaneously displayed along with the plurality of OCTA images captured at different times. The operator can thus suitably comprehend time-series changes related to blood vessels, and the operator's diagnostic decision-making can be assisted.

### First Modification of Ninth Embodiment

Next, a first modification of the foregoing ninth embodiment will be described as a modification of the ninth embodiment.

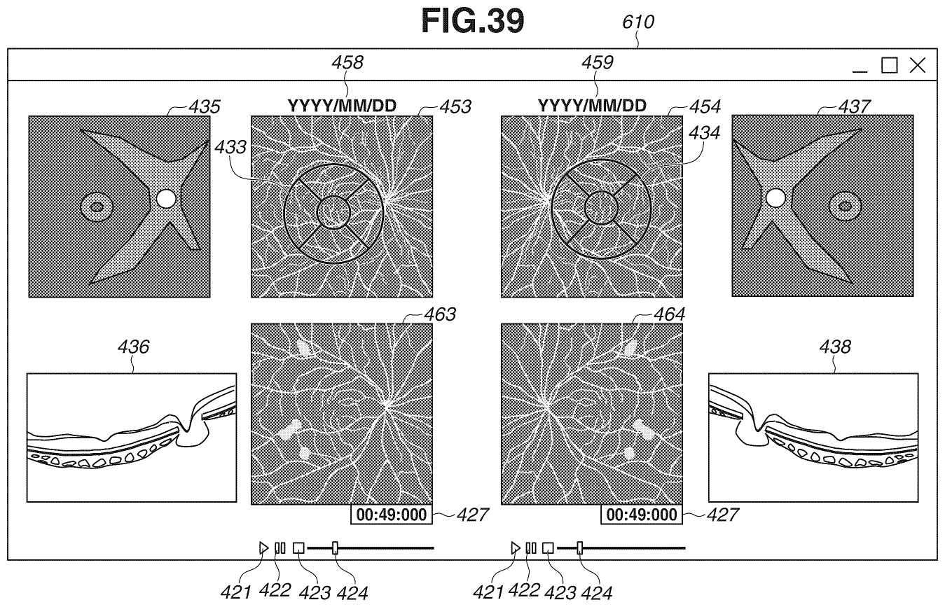

FIG. 39 is a diagram illustrating an example of a GUI screen 610 displayed on the display 230 of the image generation apparatus 20 according to the ninth embodiment. The GUI screen 610 is an example of a screen that displays a plurality of medical images (for example, OCTA images of left and right eyes) captured at different times side by side. The display unit 253 performs processing for displaying the right eye's OCTA image acquired by the image acquisition unit 251 in an image display area 453 of the GUI screen 610 and displaying a date and time 458 of capture of the OCTA image. The display unit 253 also performs processing for displaying a contrast-enhanced image output from the output unit 252 in a display area 463. The display unit 253 further displays a retinal layer thickness image generated based on the OCT in an image display area 435, and an OCT cross-sectional image in an image display area 436. The retinal layer thickness image shall be an image indicating thickness in the same depth range as the OCTA image.

The display unit 253 similarly displays the left eye's OCTA image, contrast-enhanced image, retinal layer thickness image, and OCT cross-sectional image in image display areas 454, 464, 437, and 438, respectively. Like the display of a plurality of contrast-enhanced images of the same eye, the moving image display of the contrast-enhanced images of the left and right eyes can also be synchronously operated or independently operated using GUI screen components (421 to 424).

In FIG. 39, analysis grids 433 and 434 are superimposed on the left-and right-eye OCTA images. Values obtained by analyzing the area density and skeleton density of portions corresponding to blood vessels in the OCTA images can thereby be numerically displayed in respective grid regions.

The retinal layer thickness images, OCT cross-sectional images, analysis grids, and the like described in the first modification of the ninth embodiment may similarly be displayed on the GUI screens described in the first to ninth embodiments.

In the first modification of the ninth embodiment, a plurality of OCTA images (left-and right-eye OCTA images) captured at different times and their contrast-enhanced images can be simultaneously displayed. Moreover, the display of the thickness images, cross-sectional images, and analysis grids enables the operator to suitably comprehend information about the blood vessels and morphological information about the retinal layers, and the operator's diagnostic decision-making can be assisted.

### Tenth Embodiment

Next, a tenth embodiment will be described. In the following description of the tenth embodiment, items common to the foregoing first to ninth embodiments will be omitted, and differences from the foregoing first to ninth embodiments will be described.

An image generation system including an image generation apparatus according to the tenth embodiment has a schematic configuration similar to that of the image generation system 1 including the image generation apparatus 20 according to the eighth embodiment illustrated in FIG. 34.

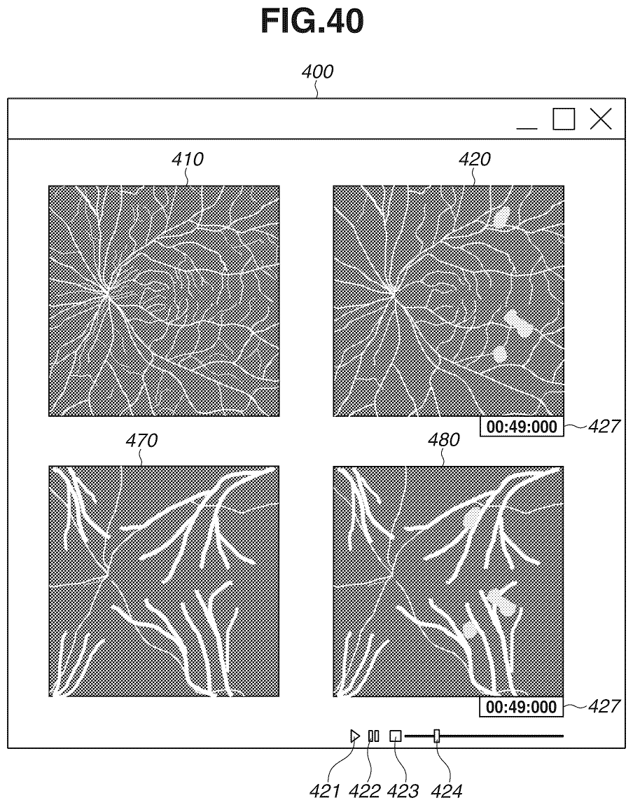

FIG. 40 is a diagram illustrating an example of the GUI screen 400 displayed on the display 230 of the image generation apparatus 20 according to the tenth embodiment. The GUI screen 400 is an example of a screen that displays medical images acquired by the image acquisition unit 251 in image display areas 410 and 470 and displays contrast-enhanced images output from the output unit 252 in image display areas 420 and 480.

More specifically, the tenth embodiment provides a display method that enables simultaneous observation of an OCTA image and an FA examination image-like pseudo contrast-enhanced image of the superficial layer, as well as an OCTA image and an indocyanine green angiography (IA) examination image-like pseudo contrast-enhanced image of the choroidal vascular NW. In FIG. 40, the OCTA image of the choroidal vascular NW is displayed in the image display area 470, and the IA examination image-like pseudo contrast-enhanced image is displayed in the display area 480. Instead of the OCTA image of the choroidal vascular NW, an en face image of brightness values generated from an OCT image in the choroidal depth range may be used. In such a case, the image generation model 2520 is trained with an en face image that is a still image and an IA examination image that is a moving image for a predetermined contrast time period (contrast duration) as a set (pair) of teaching data. In the present embodiment, a plurality of image generation models 2520 is provided, and images are generated by selecting image generation models 2520 depending on the respective images to be processed. While two medical images and their contrast-enhanced images are displayed here, these medical images are generated from a single examination image, not from examination images captured at different times. More specifically, the medical images are generated from different depth ranges of an examination image. FIG. 40 illustrates an example of displaying images for which the same moving image generation conditions described in the eighth embodiment are set. With common GUI screen components (421 to 424) capable of moving image playback and seek operations, the moving images of the different depth ranges can be synchronously operated. The images are not limited to screen display, and can be stored as still images or moving images of different depth ranges in the storage circuit 240 such as an HDD and an SSD, as described in the eighth embodiment. The images of the respective different depth ranges may be separately stored as illustrated in FIGS. 37A and 37B. The OCTA images and contrast-enhanced images of the different depth ranges and the time may be stored as a single still image or moving image, as illustrated in FIG. 37C.

While FIG. 40 illustrates an example where medical images of different depth ranges are displayed based on one examination image, this is not restrictive. As described in the ninth embodiment, medical images of respective different depth ranges may be generated from a plurality of examination images captured at different times, and displayed. In the case of displaying a plurality of medical images captured at a plurality of different times with different moving image generation conditions, the GUI screen components (421 to 424) may be displayed for each image so that the moving images can be independently operated.

As described above, in the image generation apparatus 20 according to the tenth embodiment, the image acquisition unit 251 acquires OCTA images or en face images that are medical images from the imaging apparatus 10, for example. The imaging condition acquisition unit 254 acquires imaging conditions that include a contrast duration including at least one contrast time. The output unit 252 outputs contrast-enhanced images depicting contrast effects corresponding to the contrast duration based on the OCTA images or en face images acquired by the image acquisition unit 251 and the imaging conditions acquired by the imaging condition acquisition unit 254.

With such a configuration, contrast-enhanced images of different depth ranges can be simultaneously displayed along with the OCTA images or en face images of the different depth ranges. An FA examination image-like image and an IA examination image-like image depicting contrast effects corresponding to a contrast time when the operator wants to conduct observation can thus be suitably acquired, and the operator's diagnostic decision-making can be assisted.

### Eleventh Embodiment

Next, an eleventh embodiment will be described. In the following description of the eleventh embodiment, items common to the foregoing first to tenth embodiments will be omitted, and differences from the foregoing first to tenth embodiments will be described.

An image generation system including an image generation apparatus according to the eleventh embodiment has a schematic configuration similar to that of the image generation system 1 including the image generation apparatus 20 according to the eighth embodiment illustrated in FIG. 34.

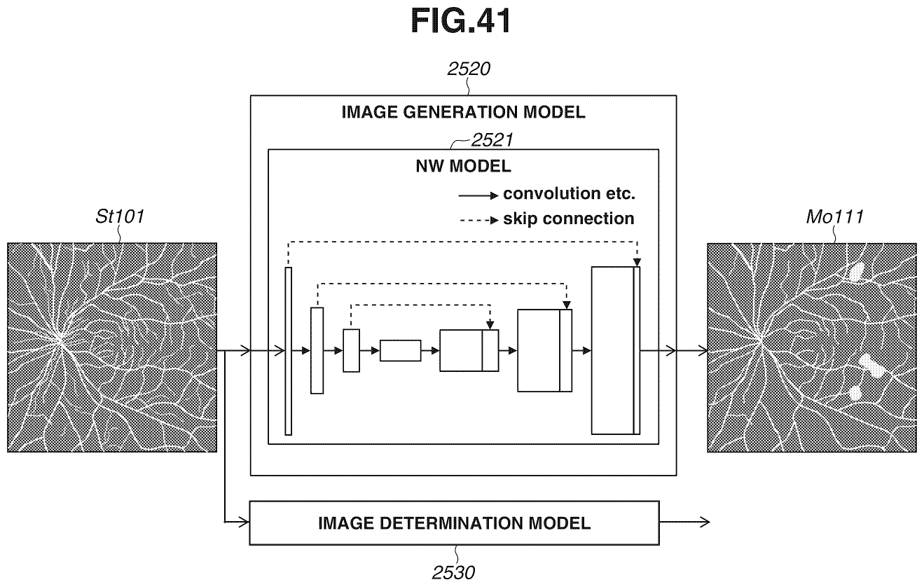

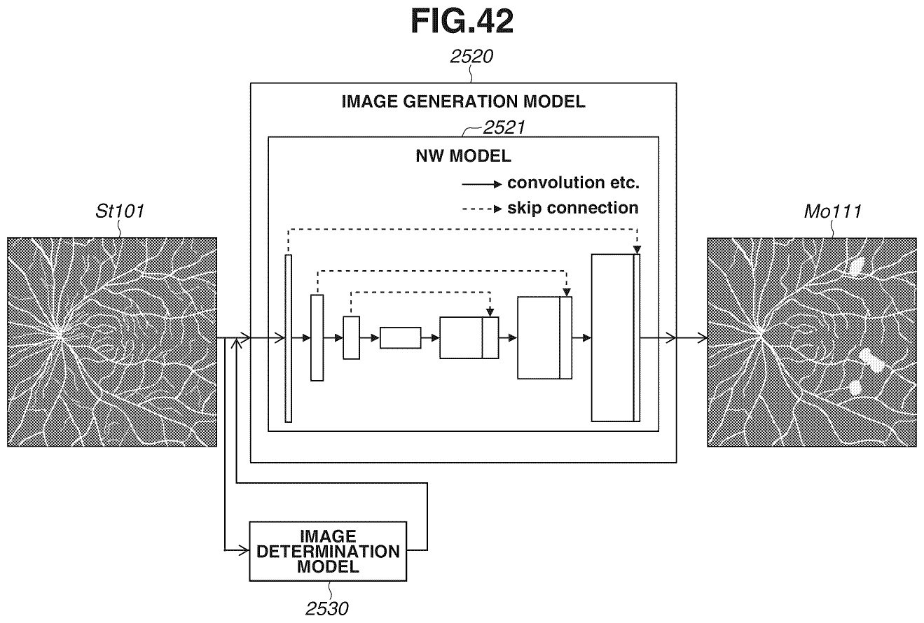

FIGS. 41 and 42 are diagrams for describing the concept of the image generation model 2520 and an image determination model 2530 included in the output unit 252 of the image generation apparatus 20 according to the eleventh embodiment.

The image generation model 2520 illustrated in FIG. 41 is a model including an image processing system that outputs a contrast-enhanced image using rule-based approaches or machine learning (in particular, deep learning techniques), for example. The image determination model 2530 is a model that determines image quality, image artifacts, and the like of an input image St101. The image determination model 2530 can use typical machine learning (such as a support vector machine and boosting), deep learning, or image processing.

In the eleventh embodiment, if the imaging apparatus 10 is an OCT device, a not-illustrated tracking unit tracks eye motion during imaging. If blinking occurs, the imaging apparatus 10 performs rescanning to acquire a three-dimensional tomographic image. However, artifacts may remain in the acquired image if the eye movement is large or blinking is frequent. Moreover, vessel recognition may be difficult in cases such as when the acquired image is dark due to eye conditions. The image determination model 2530 determines the image quality and the degree of artifact of the image input to the image generation model 2520, and outputs the determination result. Specifically, the image determination model 2530 outputs an indicator indicating the reliability of the output contrast-enhanced image. The image generation model 2520 is a model that determines reliability to be low when the image is too dark, too bright, or includes many artifacts due to eye movement. Examples of the reliability indicator include color (such as red for low reliability and blue for high reliability), numerical values (such as low values for lower reliability and high values for higher reliability), messages, and icons. The indicator is displayed on the display 230 along with the contrast-enhanced image.

The image determination model 2530 illustrated in FIG. 42 is a model that determines locations where the input image St101 has poor image quality and locations where artifacts exist, and outputs the results. Specifically, the image determination model 2530 detects locations where artifacts exist in the input image St101, and sets mask regions at those portions. The image determination model 2530 then inputs the mask-applied input image St101 to the image generation model 2520 to obtain the output image Mo111.

By setting mask regions to the input image St101, the contrast-enhanced image can be output without processing the inappropriate regions. In outputting the output image Mo111, the locations of the mask-set regions may be displayed. In addition to the setting and processing of masks, indicators indicating the reliability of the contrast-enhanced image may be output together.

As described above, in the image generation apparatus 20 according to the eleventh embodiment, the image acquisition unit 251 acquires a plurality of OCTA images that are medical images from the imaging apparatus 10, for example. The imaging condition acquisition unit 254 acquires imaging conditions that include a contrast duration including at least one contrast time. The output unit 252 then outputs a contrast-enhanced image depicting contrast effects corresponding to the contrast duration based on the OCTA images acquired by the image acquisition unit 251, the imaging conditions acquired by the imaging condition acquisition unit 254, and the image determination model 2530.

With such a configuration, the reliability of the contrast-enhanced image can be suitably acquired, and the operator's diagnostic decision-making can be assisted.

### Twelfth Embodiment

Next, a twelfth embodiment will be described. In the following description of the twelfth embodiment, items common to the foregoing first to eleventh embodiments will be omitted, and differences from the foregoing first to eleventh embodiments will be described.

An image generation system including an image generation apparatus according to the twelfth embodiment has a schematic configuration similar to that of the image generation system 1 including the image generation apparatus 20 according to the eighth embodiment illustrated in FIG. 34.

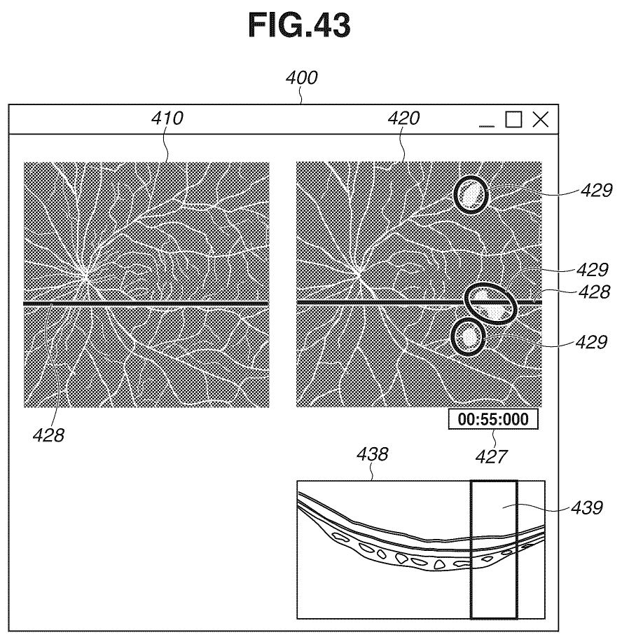

FIG. 43 is a diagram illustrating an example of the GUI screen 400 displayed on the display 230 of the image generation apparatus 20 according to the twelfth embodiment. The GUI screen 400 is an example of a screen that, when displaying a medical image acquired by the image acquisition unit 251 in the image display area 410 and a contrast-enhanced image output from the output unit 252 in the image display area 420, displays locations of the contrast-enhanced image where large changes are.

In the twelfth embodiment, a not-illustrated difference detection unit detects differences between the OCTA image input to the output unit 252 and the output contrast-enhanced image, and performs display that indicates the differences to the operator. FIG. 43 illustrates an example of displaying the time when the differences between the input and output are largest, along with the contrast-enhanced image at that time. Indicators 429 are superimposed on the regions of the contrast-enhanced image where the large differences are. The indicators 429 may be circular or rectangular areas surrounding the regions where the magnitude of difference is higher than a given threshold. The regions reaching or exceeding a threshold may be displayed in color. Aside from the use of the indicators 429, the difference regions may be displayed by displaying a difference image between the input OCTA image and the output contrast-enhanced image in a not-illustrated image display area beside the images, or by displaying the contrast-enhanced image and the difference image in the same image display area in a switching manner. The differences do not need to be ones detected between the input image and the output image, and may be ones between output images generated at different times (such as times 30 sec and 60 sec). Alternatively, the differences may be ones between synthesized images of output images generated at different times (such as an average image of times 30 to 35 sec and an average image of times 60 to 65 sec).

The initial position of an OCT cross-sectional image 438 displayed when the GUI screen 400 is first activated may be automatically set at a position where the region of the largest difference is sectioned. The OCT cross-sectional image 438 may display a region 439 representing an indicator 429 reaching or exceeding the threshold in the contrast-enhanced image. The position of the OCT sectional image 438 can be changed using a not-illustrated operation unit. Indicators 428 indicating the position of the OCT cross-sectional image 438 displayed may be superimposed on the OCTA image and the contrast-enhanced image. Motion contrast data may be superimposed on the OCT cross-sectional image 438.

While, in the twelfth embodiment, the time with the largest differences is described to be displayed along with the contrast-enhanced image at that time, this is not restrictive. The contrast-enhanced image may be a moving image instead of a still image. In such a case, the moving image is played back using GUI screen components capable of playback and seek operations of the moving image, and indicators 429 indicating differences are displayed on the moving image frames. Alternatively, a difference image may be displayed as a moving image instead of the contrast-enhanced image. Such moving images can be displayed in a switching manner or side by side. As employed herein, the difference image is an example of a difference detection result. Examples of the difference detection result include indicators, colors, and difference images.

As described above, in the image generation apparatus 20 according to the twelfth embodiment, the image acquisition unit 251 acquires an OCTA image that is a medical image from the imaging apparatus 10, for example. The imaging condition acquisition unit 254 acquires imaging conditions that include a contrast duration including at least one contrast time. The output unit 252 then outputs a contrast-enhanced image depicting contrast effects corresponding to the contrast duration based on the OCTA image acquired by the image acquisition unit 251 and the imaging conditions acquired by the imaging condition acquisition unit 254.

Such a configuration enables the display of changes in the contrast-enhanced image, and the operator's diagnostic decision-making can be supported.

### Thirteenth Embodiment

Next, a thirteenth embodiment will be described. In the following description of the thirteenth embodiment, items common to the foregoing first to twelfth embodiments will be omitted, and differences from the foregoing first to twelfth embodiments will be described.

In the foregoing first to twelfth embodiments, the image generation apparatus 20 is described to be provided as a generation apparatus. The thirteenth embodiment deals with a case where an image generation model generation apparatus is provided.

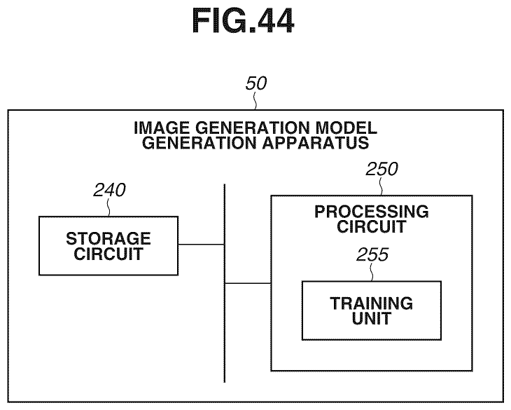

FIG. 44 is a diagram illustrating an example of a schematic configuration of an image generation model generation apparatus 50 according to the thirteenth embodiment. In FIG. 44, components similar to those illustrated in FIGS. 1 and 11 are denoted by the same reference numerals. A detailed description thereof will be omitted.

As illustrated in FIG. 44, the image generation model generation apparatus 50 includes a storage circuit 240 and a processing circuit 250.

The processing circuit 250 illustrated in FIG. 44 comprehensively controls operation of the image generation model generation apparatus 50 and performs various types of processing. As illustrated in FIG. 44, the processing circuit 250 includes a training unit 255. In the present embodiment, a program for causing a computer to function as the training unit 255 of the processing circuit 250 is stored in the storage circuit 240 in the form of a computer-executable program. For example, the processing circuit 250 is a processor that implements the functions of the training unit 255 by reading the program from the storage circuit 240 and executing the program.

The training unit 255 has a function of acquiring a teaching data group included in a dataset for training an image generation model stored in the storage circuit 240, and training the image generation model. The training unit 255 trains the image generation model using training data that includes medical images described in the first to twelfth embodiments, contrast-enhanced images related to the medical images, and imaging condition groups related to the contrast-enhanced images and each including a contrast duration including at least one contrast time. Specifically, using the foregoing training data, the training unit 255 trains an image generation model that, when a medical image related to the medical images and a contrast duration are input, generates a contrast-enhanced image depicting contrast effects corresponding to the contrast duration based on the medical image.

### Other Embodiments

The foregoing first to thirteenth embodiments have dealt with the cases where contrast-enhanced images are generated using an image generation model, and the contrast-enhanced images are displayed or stored. In displaying or storing the contrast-enhanced images, that these images are generated by an image generation model may be displayed. For example, when a contrast-enhanced is displayed on a GUI screen, the operator may be notified that the image is not an actually acquired one by displaying a message indicating an “image generated by an image generation model” near the image, displaying an icon, or displaying the image with a colored border. Not only in the case of displaying but also in the case of storing, the operator may be similarly notified using messages, icons, and the like.

In the foregoing sixth embodiment, the image generation model 2520 is described to be selected based on the imaging conditions acquired by the imaging condition acquisition unit 254. However, the present disclosure is not limited thereto. For example, an image generation model may be selected from ones trained for specific diseases (such as diabetic retinopathy, retinal vein occlusion, age-related macular degeneration, and Vogt-Koyanagi-Harada disease) depending on the subject's disease. Each image generation model does not necessarily need to correspond to a single disease. There may be image generation models trained for a plurality of diseases (such as diabetic retinopathy and retinal vein occlusion). For model selection, a not-illustrated disease determination model may automatically determine the disease based on the input image, and the image generation model may be selected based on the determination result. The operator may select an image generation model from the image generation models for respective diseases, using a not-illustrated selection unit. Alternatively, disease information may be acquired from the subject's medical record information, and the image generation model may be selected based on the information.

In the foregoing sixth embodiment, the image generation model is described to be selected based on the imaging conditions acquired by the imaging condition acquisition unit 254. However, if there is no image generation model corresponding to the imaging conditions acquired by the imaging condition acquisition unit 254, the processing for generating a contrast-enhanced image might not be performed. For example, if the imaging apparatus 10 acquires only one OCT image captured by line scan and there is no corresponding image generation model, the processing for generating a contrast-enhanced image may be skipped.

In the foregoing seventh embodiment, a CT image and a contrast-enhanced CT image are described as examples of radiological images. However, the present disclosure is not limited thereto. For example, similar processing may be performed between a contrast-enhanced CT image in a certain time phase and a contrast-enhanced CT image in a different time phase. Similar processing may be performed between images acquired by different types of imaging apparatuses, such as an MRI image and a contrast-enhanced CT image.

Contrast-enhanced images output from the output unit 252 may be processed into other types of images that indicates contrast effects, such as described in the second modification of the third embodiment. In other words, contrast-enhanced images output from the output unit 252 do not need be displayed in their original form.

In the foregoing eighth embodiment, the operator is described to set the numerical values. If numerical values invalid for generating a moving image are input (e.g., when the start time value is greater than the end time value), a message that the settings are invalid may be displayed and default values may be applied. Alternatively, the OK button 501 may be made unselectable. The OK button 501 may be made selectable when numerical values suitable for generating a moving image are input.

Contrast-enhanced images may be displayed with other types of images that indicate contrast effects as described in the second modification of the third embodiment. For example, region segmentations illustrating the leakage ranges of the contrast agent, contours of the leakage ranges, or regions obtained by coloring an FA examination image using a color lookup table may be superimposed on contrast-enhanced images.

The present disclosure can also be implemented by processing of supplying a program for implementing one or more functions of the foregoing embodiments to a system or an apparatus via a NW or a storage medium, and reading and executing the program by one or more processors in a computer of the system or apparatus. A circuit for implementing one or more functions (such as an application-specific integrated circuit [ASIC]) can also be used for implementation.

This program and a computer-readable storage medium storing the program are included in the present disclosure.

All the foregoing embodiments of the present disclosure are merely examples of specific implementation of the present disclosure, and the technical scope of the present disclosure is not to be interpreted as being limited thereto. In other words, the present disclosure can be practiced in various forms without departing from the technical concept or essential features thereof.

The present disclosure is not limited to the foregoing embodiments, and various changes and modifications can be made without departing from the spirit or scope of the present disclosure. The following claims are therefore appended to make public the scope of the present disclosure.

According to the present disclosure, images depicting contrast effects corresponding to a specific contrast time can be suitably acquired and displayed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image generation apparatus comprising:
an image acquisition unit configured to acquire an ophthalmic examination image; and
an output unit configured to input the acquired ophthalmic examination image and at least one contrast time as input data of an image generation model configured to generate a contrast-enhanced image depicting a contrast effect, and thereby provide output of at least one contrast-enhanced image output as output data of the image generation model along with the at least one contrast time.

2. The image generation apparatus according to claim 1, wherein the output unit includes a display control unit configured to provide the output by controlling display of the at least one contrast-enhanced image and the at least one contrast time on a display device.

3. The image generation apparatus according to claim 2,
wherein the image acquisition unit is configured to acquire a plurality of ophthalmic examination images,
wherein the output unit is configured to output a plurality of contrast-enhanced images each depicting a contrast effect corresponding to at least one contrast time based on the plurality of ophthalmic examination images, and
wherein the display control unit is configured to display both the plurality of ophthalmic examination images and the plurality of contrast-enhanced images on the display device.

4. The image generation apparatus according to claim 3, wherein the ophthalmic examination images are images of a same eye captured at different times or images of left and right eyes captured at different times.

5. The image generation apparatus according to claim 2,
wherein the image acquisition unit is configured to acquire at least two different ophthalmic examination images from an ophthalmic examination image,
wherein the output unit is configured to output a contrast-enhanced image depicting a contrast effect corresponding to at least one contrast time for each of the at least two different ophthalmic examination images, and
wherein the display control unit is configured to display both the at least two different ophthalmic examination images and the at least two different contrast-enhanced images on the display device.

6. The image generation apparatus according to claim 5, wherein the ophthalmic examination image is a same eye's image generated at different depths.

7. The image generation apparatus according to claim 2, further comprising a difference detection unit configured to detect a difference between the ophthalmic examination image and the contrast-enhanced image depicting the contrast effect corresponding to the at least one contrast time or a difference between a plurality of contrast-enhanced images corresponding to a plurality of contrast times as a difference detection result,
wherein the difference detection unit is configured to output at least one of an indicator, color, and a difference image as the difference detection result, and
wherein the display control unit is configured to display the difference detection result on the display device along with either the ophthalmic examination image or the contrast-enhanced image.

8. The image generation apparatus according to claim 1, wherein the output unit includes a storage control unit configured to provide the output by controlling storage of the at least one contrast time in a storage unit along with the at least one contrast-enhanced image.

9. The image generation apparatus according to claim 8,
wherein the image acquisition unit is configured to acquire a plurality of ophthalmic examination images,
wherein the output unit is configured to output a plurality of contrast-enhanced images each depicting a contrast effect corresponding to at least one contrast time based on the plurality of ophthalmic examination images, and
wherein the storage control unit is configured to store both the plurality of ophthalmic examination images and the plurality of contrast-enhanced images in the storage unit.

10. The image generation apparatus according to claim 9, wherein the ophthalmic examination images are images of a same eye captured at different times or images of left and right eyes captured at different times.

11. The image generation apparatus according to claim 8,
wherein the image acquisition unit is configured to acquire at least two different ophthalmic examination images from an ophthalmic examination image,
wherein the output unit is configured to output a contrast-enhanced image depicting a contrast effect corresponding to at least one contrast time for each of the at least two different ophthalmic examination images, and
wherein the storage control unit is configured to store both the at least two different ophthalmic examination images and the at least two different contrast-enhanced images in the storage unit.

12. The image generation apparatus according to claim 11, wherein the ophthalmic examination image is a same eye's image generated at different depths.

13. The image generation apparatus according to claim 1, further comprising an image determination model configured to evaluate image quality of the ophthalmic examination image,
wherein the output unit is configured to output the contrast time along with the contrast-enhanced image depicting the contrast effect, and
wherein the image determination model is configured to output image reliability based on the image quality of the ophthalmic examination image.

14. The image generation apparatus according to claim 13,
wherein a mask is applied to the ophthalmic examination image based on the image reliability output by the image determination model, and
wherein the image generation model is configured to output the contrast-enhanced image depicting the contrast effect corresponding to the at least one contrast time based on the mask-applied ophthalmic examination image.

15. The image generation apparatus according to claim 1, wherein the output unit is configured to, in outputting the contrast-enhanced image, output that the contrast-enhanced image is an image generated by the image generation model.

16. The image generation apparatus according to claim 1,
wherein the at least one contrast time input as the input data of the image generation model is at least one contrast time set based on an instruction from an operator, and
wherein the output unit is configured to output the at least one set contrast time along with the at least one contrast-enhanced image output as the output data of the image generation model.

17. The image generation apparatus according to claim 1,
wherein a plurality of contrast times input as the input data of the image generation model is a plurality of contrast times corresponding to an interval set based on an instruction from an operator, and
wherein the output unit is configured to output the plurality of set contrast times along with a plurality of contrast-enhanced images output as the output data of the image generation model.

18. An image generation method comprising:
acquiring an ophthalmic examination image; and
inputting the acquired ophthalmic examination image and at least one contrast time as input data of an image generation model configured to generate a contrast-enhanced image depicting a contrast effect, and thereby providing output of at least one contrast-enhanced image output as output data of the image generation model along with the at least one contrast time.

19. A storage medium storing a program for causing a computer to perform the image generation method according to claim 18.
